(19) United States
(12) Patent Application Publication
(10) Pub. No.: US 2011/0221931 A1
(43) Pub. Date: Sep. 15, 2011

(54) Temperature information output apparatus, imaging apparatus, method of outputting temperature information

(75) Inventors: Hayato Wakabayashi, Tokyo (JP); Masatoshi Hara, Kanagawa (JP)

(73) Assignee: Sony Corporation, Tokyo (JP)

(21) Appl. No.: 12/929,600

(22) Filed: Feb. 3, 2011

(30) Foreign Application Priority Data
Mar. 9, 2010 (JP) 2010-051223

(51) Int. Cl. H04N 5/235; G01K 7/00

(52) U.S. Cl. 348/229.1; 374/170; 374/E07.001; 348/E05.037

(57) ABSTRACT

A temperature information output apparatus includes: a first comparison unit provided to match with a specific row in a pixel array unit and receiving and comparing an analog pixel signal output from a pixel and a reference signal having a ramp waveform having a predetermined inclination and a signal period; a first count unit carrying out a count operation during a count period within a reset period and a count period within a signal period; a first data output unit outputting the pixel data based on a count value obtained by the first count unit; a local voltage/temperature signal generating unit generating a local voltage and a temperature signal; a second comparison unit receiving and comparing the temperature signal and the reference signal; a second count unit carrying out a count operation during a count period within a reset period and a count period within a signal period; and a second data output unit outputting temperature data based on a count value obtained by the second count unit.

### BACKGROUND OF THE INVENTION

1. Field of the Invention

The present invention relates to a temperature information output apparatus, and more particularly, to a temperature information output apparatus, an imaging apparatus, and a method of outputting temperature information, by which a temperature is detected from an imaging device to output temperature information.

2. Description of the Related Art

Sometimes, in electronic apparatuses, a circuit or device may be configured to detect a temperature and output the resulting temperature information, for example, in order to compensate for temperature characteristics of elements included in the circuit and obtain stable operations.

As an exemplary configuration for outputting the temperature information, there is known an example using a temperature characteristic of a diode. For example, there is known a solid-state imaging device such as a complementary metal oxide semiconductor (CMOS) image sensor using a temperature characteristic of the diode connected to a constant current source. There is known a configuration that outputs the temperature information by comparing the voltage obtained in such a diode with a fixed reference voltage using a comparator (e.g., refer to JP-A-2008-42305, FIG. 11).

As another configuration for outputting temperature information, for example, there is known an example in which a voltage varying depending on the temperature is generated by a band gap reference circuit. In addition, this voltage is converted into a digital signal using an analog-to-digital converter (ADC) and output as temperature information (e.g., refer to JP-A-2008-71335, FIG. 5).

### SUMMARY OF THE INVENTION

In the techniques described above, temperature information of all circuits can be output. However, for example, when the temperature characteristic of the diode is used, the temperature information is used as an analog amount itself, which directly depends on the temperature characteristic of the diode. For this reason, it may be difficult to obtain a sufficiently high precision, and it may be easy to generate errors due to a process variation.

On the contrary, if the temperature information is created using the band gap reference circuit, it is possible to reduce errors caused by the process variation. However, in this case, it is necessary to separately provide an ADC capable of accurately detecting a small change of the voltage caused by temperature change from the band gap reference circuit, and it generates problems such as an increasing chip area of an integrated circuit by a corresponding amount.

Thus, it is desirable to provide a configuration for outputting temperature information created from the circuits such as an image sensor, by which the chip area is prevented from increasing, and temperature information can be obtained with high precision.

According to an embodiment of the invention, there is provided a temperature information output apparatus including: a first comparison unit that is provided to match with a single specific row of pixels in a pixel array unit in which pixels are arranged in a matrix shape and receives and compares as one input signal an analog pixel signal output from a pixel selected by row scanning in the matching row of pixels and as the other input signal a reference signal having a ramp waveform having a predetermined inclination depending on a reset period in which a reset level is obtained from the pixel signal and a signal period in which a signal level corresponding to a received light amount is obtained, the inclination of the reference signal varying depending on a gain specified for pixel data; a first count unit that carries out a count operation during a count period within a reset period after the reset period is initiated until an output of the first comparison unit is inverted and a count period within a signal period after the signal period is initiated until an output of the first comparison unit is inverted; a first data output unit that outputs the pixel data in a digital format based on a count value obtained through a count operation carried out by the first count unit during the count period within the signal period and the count period within the reset period; a local voltage/temperature signal generating unit that generates a local voltage which has a predetermined voltage value different from a power voltage and is supplied to a predetermined circuit and generates a temperature signal obtained by changing a temperature-related voltage value which varies depending on temperature change based on a ratio corresponding to a specified gain; a second comparison unit that receives and compares as one input signal the temperature signal and as the other input signal the reference signal having the ramp waveform; a second count unit that carries out a count operation during a count period within a reset period after the reset period is initiated until the output of the second comparison unit is inverted and a count period within a signal period after the signal period is initiated until the output of the first comparison unit is inverted; and a second data output unit that outputs temperature data in a digital format based on a count value obtained through the count operation carried out by the second count unit during the count period within the reset period and the count period within the signal period. As a result, in response to changing the inclination of the reference signal to change the gain, the voltage value of the temperature signal input to the second comparison unit changes depending on the ratio corresponding to a gain scale factor.

In the embodiment of the invention, the local voltage generating unit may generate a temperature-related voltage value as a voltage between both ends of a predetermined number of resistors connected in series, change a voltage dividing point set by a series of the resistors based on a specified gain, and output the temperature signal from the voltage dividing point. As a result, it is possible to switch the voltage value of the temperature signal just by a simple operation such as changing the voltage dividing point in a series of resistors.

In the embodiment of the invention, the second comparison unit may be provided to match with a single specific row of pixels different from a row of pixels matching with the first comparison unit and receive the temperature signal instead of the pixel signal output from the specified matching row of pixels. As a result, a configuration for A/D conversion of the pixel signal can be used as an A/D conversion unit for outputting the temperature data.

In the embodiment of the invention, the specified row of pixels matching with the second comparison unit may be a row of pixels within an image processing ineffective area including an ineffective pixel whose pixel signal is not used in image processing out of areas set in the pixel array unit. As a result, the temperature data are created using a row of pixels that does not affect creation of the image data.

In the embodiment of the invention, period-related temperature data representing temperatures for each predetermined unitary period may be created based on a plurality of pieces of temperature data output from the second data output unit in each predetermined unitary period. As a result, the temperature information can be created from a plurality of pieces of temperature data corresponding to a predetermined unitary period.

In the embodiment of the invention, the predetermined unitary period may be a period based on a frame period. As a result, for example, it is possible to obtain temperature data corresponding to each single frame period.

According to another embodiment of the invention, there is provided an imaging apparatus including: an optical system where light is incident; a pixel array unit in which pixels receiving light incident to the optical system are arranged in a matrix shape; a gain specifying unit that specifies a gain applied to pixel data created based on a signal obtained from pixels of the pixel array unit; a reference signal generating unit that generates a reference signal having a ramp waveform having a predetermined inclination according to a signal period and a reset period of the pixel signal, the inclination changing depending on the gain specified by the gain specifying unit; a first count unit that carries out a count operation during a count period within a reset period after the reset period is initiated until an output of the first comparison unit is inverted and a count period within a signal period after the signal period is initiated until an output of the first comparison unit is inverted; a first data output unit that outputs the pixel data in a digital format based on a count value obtained through a count operation carried out by the first count unit during the count period within the signal period and the count period within the reset period; a local voltage/temperature signal generating unit that generates a local voltage which has a predetermined voltage value different from a power voltage and is supplied to a predetermined circuit and generates a temperature signal obtained by changing a temperature-related voltage value which varies depending on temperature change based on a ratio corresponding to a specified gain; a second comparison unit that receives and compares as one input signal the temperature signal and as the other input signal the reference signal having the ramp waveform; a second count unit that carries out a count operation during a count period within a reset period after the reset period is initiated until the output of the second comparison unit is inverted and a count period within a signal period after the signal period is initiated until the output of the first comparison unit is inverted; and a second data output unit that outputs temperature data in a digital format based on a count value obtained through the count operation carried out by the second count unit during the count period within the reset period and the count period within the signal period. As a result, in the image apparatus, in response to changing the inclination of the reference signal to change the gain, the voltage value of the temperature signal input to the second comparison unit changes according to the ratio corresponding to a gain scale factor.

In addition, in the embodiment of the invention, a correction processing unit that executes correction for a predetermined correction target based on the temperature data may be further provided. As a result, it is possible to appropriately correct a predetermined target necessitating temperature compensation.

In the embodiment of the invention, the gain specifying unit may determine the gain to be specified depending on exposure determined by an automatic exposure control. As a result, in the image apparatus capable of carrying out the automatic exposure control, the level of the temperature signal can appropriately switch depending on gain change.

According to still another embodiment of the invention, there is provided a temperature information output apparatus including: a first comparison unit that is provided to match with a single specific row of pixels in a pixel array unit in which pixels are arranged in a matrix shape and receives and compares as one input signal an analog pixel signal output from a pixel selected by row scanning in the matching row of pixels and as the other input signal a reference signal having a ramp waveform having a predetermined inclination depending on a reset period of the pixel signal and a signal period; a first count unit that carries out a count operation during a count period within a reset period after the reset period is initiated until an output of the first comparison unit is inverted and a count period within a signal period after the signal period is initiated until an output of the first comparison unit is inverted; a first data output unit that outputs the pixel data in a digital format based on a count value obtained through a count operation carried out by the first count unit during the count period within the signal period and the count period within the reset period; a local voltage/temperature signal generating unit that generates a local voltage which has a predetermined voltage value different from a power voltage and is supplied to a predetermined circuit and generates a temperature signal obtained by changing a temperature-related voltage value which varies depending on temperature change based on a ratio corresponding to a specified gain; a second comparison unit that receives and compares as one input signal the temperature signal and as the other input signal the reference signal having the ramp waveform; a second count unit that carries out a count operation during a count period within a reset period after the reset period is initiated until the output of the second comparison unit is inverted and a count period within a signal period after the signal period is initiated until the output of the first comparison unit is inverted; and a second data output unit that outputs temperature data in a digital format based on a count value obtained through the count operation carried out by the second count unit during the count period within the reset period and the count period within the signal period. As a result, it is possible to output temperature information using a combination of the image sensor employing the column ADC and a circuit configuration of generating the local voltage.

According to the embodiments of the present invention, it is possible to prevent a chip area where circuits such as an image sensor are mounted from increasing and obtain temperature information with high precision.

### BRIEF DESCRIPTION OF THE DRAWINGS

FIG. 1 is a block diagram illustrating a configuration example of an imaging apparatus according to an embodiment of the invention.

FIG. 2 is a diagram illustrating a configuration example of an image sensor according to an embodiment of the invention.

FIG. 3 is a circuit diagram illustrating a configuration example of a comparator according to an embodiment of the invention.

FIG. 4 is a timing chart illustrating an operation example of the image sensor according to an embodiment of the invention.

FIG. 5 is a diagram illustrating configuration examples of the BGR and the temperature ADC according to a first embodiment of the invention.

FIG. 6 is a timing chart illustrating an operation example of the temperature ADC according to a first embodiment of the invention.

FIG. 7 is a diagram schematically illustrating an example of setting an area in the pixel array according to an embodiment of the invention.

FIG. 8 is a flowchart illustrating a processing sequence example for obtaining frame temperature data according to an embodiment of the invention.

FIG. 9 is a flowchart illustrating a processing sequence example for a correction process based on the temperature data according to an embodiment of the invention.

FIGS. 10A to 10C are diagrams schematically illustrating an example of changing parameters for AE control using the imaging apparatus 100 according to an embodiment of the invention.

FIGS. 11A and 11B are timing charts illustrating a gain change processing example according to an embodiment of the invention.

FIG. 12 is a timing chart illustrating an error operation example in a case where the temperature signal Vtemp does not match with gain change.

FIG. 13 is a diagram illustrating configuration examples of the BGR and the temperature ADC according to a second embodiment of the invention.

FIG. 14 is a timing chart illustrating an operation using an actual voltage value for the temperature signal and the reference signal depending on the changing gain according to a second embodiment of the invention.

FIG. 15 is a waveform diagram illustrating an electric potential setting condition example of the reference signal and the temperature signal in consideration of the input terminal electric potential reset using the temperature comparator according to a second embodiment of the invention.

FIG. 16 is a waveform diagram illustrating the reference signal and the temperature signal as an operation example of the comparator 241 in consideration of the input terminal electric potential reset using the temperature comparator according to a second embodiment of the invention.

### DESCRIPTION OF THE PREFERRED EMBODIMENTS

Configurations for embodying the present invention (hereinafter, referred to as embodiments) will now be described. The description will be made in the following sequence.

1. First Embodiment (a fundamental configuration example obtained by combining a column ADC and a band gap reference circuit)

2. Second Embodiment (an example of changing a temperature detection voltage value in response to changing the gain)

### 1. First Embodiment

### [Configuration Example of Imaging Apparatus]

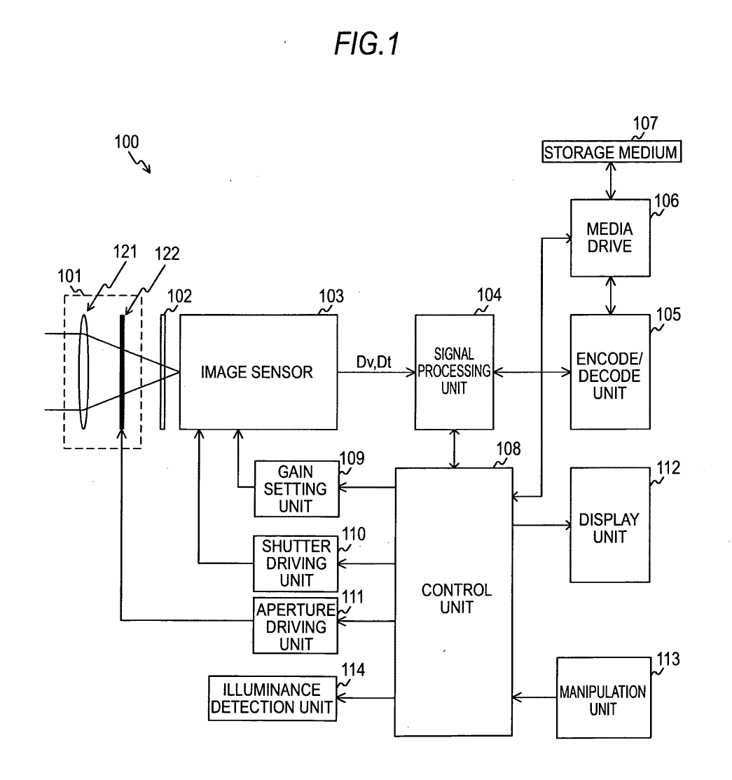

FIG. 1 is a block diagram illustrating a configuration example of the imaging apparatus 100 according to a first embodiment of the invention. The imaging apparatus 100 shown in this drawing can store the image obtained through image capturing in a storage medium as moving picture data or still image data. In addition, the configuration of the imaging apparatus 100 shown in this drawing is common to a second embodiment of the invention, which will be described below.

The imaging apparatus 100 shown in this drawing includes an optical system unit 101, a filter 102, an image sensor 103, a signal processing unit 104, an encode/decode unit 105, and a media drive 106. In addition, the imaging apparatus 100 further includes a control unit 108, a gain setting unit 109, a shutter driving unit 110, an aperture driving unit 111, an illuminance detection unit 114, a display unit 112, and a manipulation unit 113.

The optical system unit 101 performs an optical process for the incident light. The optical system unit 101 has a lens unit 121 and an aperture 122. The lens unit 121 includes a predetermined number of imaging fixed lenses, zoom lenses, and focus lenses. Although not shown in the drawings, the zoom lens and the focus lens are driven to move along an optical axis of the imaging light in response to zoom control or focusing control. The aperture 122 is a mechanism portion for adjusting the amount of the imaging light from the lens unit 121 and has an opening size depending on the aperture value using the aperture driving unit 111.

The light incident to the optical system unit 101 forms an image on the light-receiving surface of the image sensor 103 through the filter 102 as imaging light. The filter 102 removes the light component of the wavelength unnecessary in the imaging.

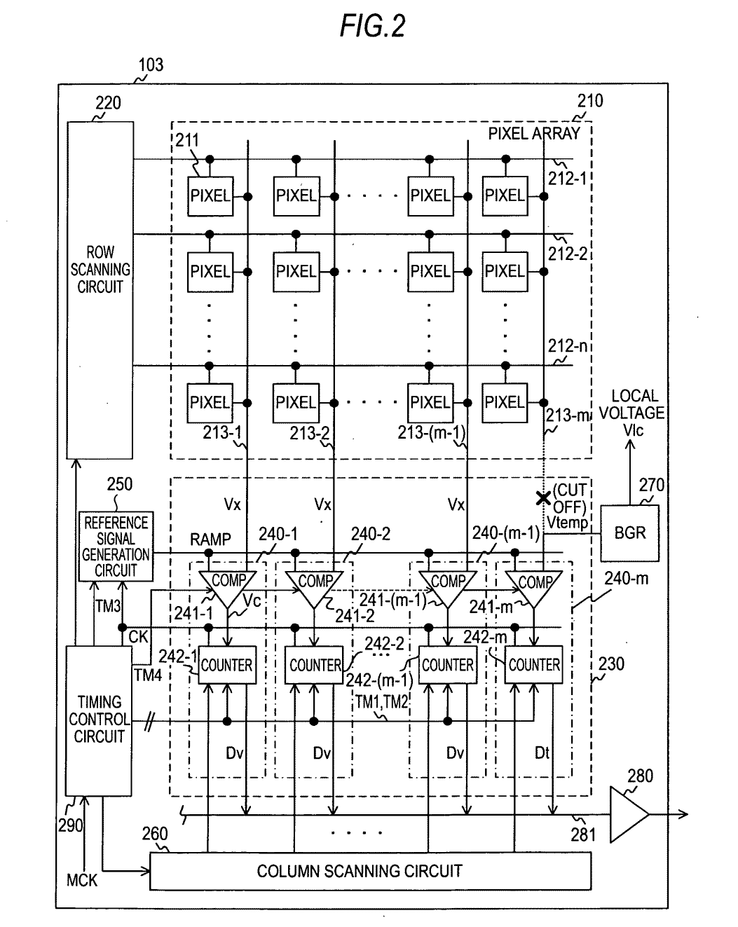

The image sensor 103 converts the imaging light incident from the optical system unit 101 into an electric signal using the solid-state imaging device and outputs an image signal. That is, the image sensor 103 performs photoelectric conversion. As such image sensors, a Charge Coupled Device (CCD) sensor, a CMOS sensor, or the like are known in the art. According to an embodiment of the invention, it is assumed that a CMOS sensor is employed. The image sensor as the CMOS sensor internally has an ADC and may be configured to output a digital image signal (imaging signal data Dv) as the image signal. In addition, according to an embodiment of the invention, the temperature data Dt is also output together with the image data from the image sensor 103. The temperature data represent the temperature of the IC chip where a circuit is mounted as the image sensor 103. The internal configuration example of the image sensor 103 capable of outputting temperature data and the image data will be described below with reference to FIG. 2.

The imaging signal data Dv output from the image sensor 103 are input to the signal processing unit 104. The signal processing unit 104 creates the image data having a moving picture type or a still image type through signal processing necessary in the input image signal data Dv.

In order to record the image data created by the signal processing unit 104 in the storage medium 107, the image data are output to the encode/decode unit 105. The encode/decode unit 105 performs compression encoding for the image data output from the signal processing unit 104 using a predetermined compression encoding scheme and adds a header or the like, for example, under control of the control unit 108 to convert the image data into compressed image data in a predetermined scheme. The resulting image data are transmitted to the media drive 106. The media drive 106 writes or stores the transmitted image data to or in the storage medium 107. In addition, the storage medium 107 may be a removable type that is detachable to the media drive 106, or may be integrated into the imaging apparatus 100 in advance such as a Hard Disc Drive (HDD).

The image apparatus 100 may display the image currently being captured, called a through-the-lens image, on the display unit 112 using the image data created by the signal processing unit 104. For this purpose, for example, the image data having a moving picture type created by the signal processing unit 104 are converted to a resolution corresponding to the display in the display unit 112 under control of the control unit 108 and transmitted to the display unit 112 for display. As a user sees the image displayed in this manner, the image currently being captured is displayed on the display unit 112 as a moving picture. In this manner, the through-the-lens images are displayed.

In addition, the imaging apparatus 100 may reproduce the image data recorded in the storage medium 107 and display the image on the display unit 112.

For this purpose, for example, in response to the reproduction manipulation for image performed by the manipulation unit 113, the control unit 108 instructs the media drive 106 to read the data from the storage medium 107 by designating the image data. In response to this instruction, the media drive 106 reads the designated image data from the storage medium 107 and transmits the read data to the encode/decode unit 105.

The encode/decode unit 105 decodes the compressed and encoded image data transmitted from the media drive 106, for example, under control of the control unit 108, and in this case, transmits the resulting image data to the signal processing unit 104. The signal processing unit 104 converts the transmitted image data with a resolution, for example, suitable for the display unit 112 and transmits the converted image data to the display unit 112. As a result, the image of the image data stored in the storage medium 107 is reproduced or displayed on the display unit 112 as a moving picture or a still image.

The control unit 108 is obtained, for example, using a Central Processing Unit (CPU) in practice. In addition, the control unit 108 is configured as a microcomputer together with a Read Only Memory (ROM), a Random Access Memory (RAM), or the like. In addition, the control unit 108 performs various kinds of control or processes in the imaging apparatus 100.

The shutter driving unit 110 controls the reading operation of the imaging signal data from the image sensor 103 under control of the control unit 108 to realize an electronic shutter. For example, the shutter speed of the electronic shutter is changed by controlling the shutter driving unit 110.

The aperture driving unit 111 changes the opening size of the aperture 122 under control of the control unit 108. For example, the control unit 108 can execute automatic exposure (AE) control. In the case of the AE control, the shutter driving unit 110, the aperture control unit 111, and the gain setting unit 109 are controlled so as to obtain the shutter speed, the opening size (aperture value) of the aperture 122, and the gain corresponding to the suitable exposure determination.

The illuminance detection unit 114 includes, for example, a photo-diode or photo-transistor to detect illuminance.

Various manipulators provided in the imaging apparatus 100 and a signal output portion that creates a manipulation signal corresponding to the manipulation made for such manipulators and outputs the manipulation signal to the control unit 108 are collectively called a manipulation unit 113. The control unit 108 performs a predetermined process in response to the manipulation signal input from the manipulation unit 113. As a result, the operation of the imaging apparatus 100 corresponding to the user's manipulation can be obtained.

### [Configuration Example of Image Sensor]

FIG. 2 illustrates a configuration example of the image sensor 103. As described above, the image sensor 103 according to the embodiment of the invention employs the CMOS sensor.

Referring to FIG. 2, the image sensor 103 includes a pixel array 210, a row (vertical) scanning circuit 220, a column ADC unit 230, and a reference signal generation circuit 250. In addition, the image sensor 103 further includes a column (horizontal) scanning circuit 260 a band gap reference circuit (hereinafter, referred to as Band Gap Reference (BGR) circuit) 270, a buffer amplifier 280, and a timing control circuit 290. While the pixel array 210 is formed, for example, on a single chip (semiconductor substrate), each portion, circuit, or the like other than the pixel array 210 shown in FIG. 2 are also formed and integrated into the same chip as that of the pixel array 210.

In the pixel array 210, a plurality of pixels 211 are arranged in a matrix shape (array shape) with n rows×m columns. Although a partial configuration of the pixel 211 is not shown herein, for example, the following elements may be provided. Specifically, for example, the pixel array 210 includes a photoelectric conversion element such as a photodiode and a transmission transistor for transmitting electric charges obtained through the photoelectric conversion using the photoelectric conversion element to the Floating Diffusion (FD) unit. Furthermore, a reset transistor for controlling the electric potential of the FD unit and an amplification transistor for outputting a signal corresponding to the electric potential of the FD unit are provided. Such a configuration is called a three-transistor structure because three transistors are used. In addition to the three-transistor structure, a four-transistor structure may be employed by providing a selection transistor for selecting the pixel.

In addition, the pixel array 210 is an example of the pixel array unit described in claims.

For arrangement of the pixels 211 in the row (horizontal) direction of the pixel array 210, first, each of the pixels 211 arranged in the first row are connected to the row control line 212-1. Similarly, each of the pixels 211 arranged in each of the remaining second to (n)th rows are connected to the row control lines 212-2 to 212-n, respectively.

In addition, for arrangement of the pixels 211 in the column (vertical) direction of the pixel array 210, each of the pixels 211 arranged in the first column are connected to the column signal line 213-1. Similarly, each of the pixels 211 arranged in each of the remaining second to (m)th columns are connected to the column signal lines 213-2 to 213-m, respectively.

Each one end of the row control lines 212-1 to 212-n is connected to the row scanning circuit 220. The row scanning circuit 220 includes, for example, a shift register, a decoder, or the like, and performs row progressive scanning by outputting the row scanning signal, for example, to the row control lines 212-1 to 212-n at a predetermined timing under control of the timing control circuit 290.

In addition, each one end of the column signal lines 213-1 to 213-m is connected to one of the input terminals of the comparators 241-1 to 241-m of the unitary ADCs 240-1 to 240-m described below.

However, according to an embodiment of the invention, among the column signal lines 213-1 to 213-m, a predetermined part of the column signal line 213 is not connected to the corresponding comparator 241 but cut off. In FIG. 2, the column signal line 213-m of the column signal lines 213-1 to 213-m is cut off without being connected to the input terminal of the corresponding comparator 241-m.

The column ADC unit 230 is provided to convert the pixel signals output from the column signal lines 213-1 to 213-m into digital signals and output the digital signals as image data. As shown in the drawings, the column ADC unit 230 has m unitary ADCs 240-1 to 240-m. The unitary ADCs 240-1 to 240-m match with the first to (m)th columns of the pixel arrangement of the pixel array 210.

For example, the unitary ADC 240-1 includes the comparator 241-1 and the counter 242-1 as shown in FIG. 2. The one of the input terminal of the comparator 241-1 is connected to the column signal line 213-1 corresponding to the first column. In other words, the pixel signal Vx from the pixel 211 of the row selected by the row scanning of the row scanning circuit 220 out of the pixels 211 connected to the column signal line 213-1 is input to the one input terminal of the comparator 241-1. The reference signal RAMP output from the reference signal generation circuit 250 described below is input to the other input terminal of the comparator 241-1. The comparator 241-1 outputs, to the counter 242-1, a signal Vc of which the level is inverted depending on a magnitude relationship between the pixel signal Vx and the reference signal RAMP input in this manner. In addition, the circuit configuration example of the comparator 241-1 will be described below.

The counter 242-1 includes, for example, an up/down counter capable of switching between an up-count operation and a down-count operation. The counter 242-1 carries out the count operation at the count period based on the clock CK input from the timing control circuit 290. In addition, the up-count and down-count operations are initiated at the timing based on the timing signals TM1 (P-phase count start pulse) and TM2 (D-phase count start pulse) input from the same timing control circuit 290. In addition, the counter 242-1 serves to latch the count value obtained through the up-count and down-count operations. In addition, the counter 242-1 of the unitary ADC 240-1 outputs the latched count value to the data output line 281.

In addition, the unitary ADCs 240-2 to 240-m corresponding to the remaining second to (m)th columns also include the comparator 241-2 to 241-m, and the counters 242-2 to 242-m having the same configurations as those of the comparator 241-1 and the counter 242-1.

In this manner, the column ADC unit 230 employs a row parallel shape in which the m unitary ADCs 240-1 to 240-m are provided to match with the first to (m)th columns in the pixel arrangement of the pixel array 210, and the signal lines of the reference signal RAMP are connected in parallel.

In addition, each of the comparators 241-1 to 241-(m−1) out of the comparators 241-1 to 241-m corresponds to an example of the first comparison unit described in the claims. In addition, each of the counters 242-1 to 242-(m−1) corresponds to an example of the first count unit described in the claims. In addition, for example, the function of latching the count value in the counters 242-1 to 242-(m−1) and outputting the count value at the column scanning timing corresponds to an example of the first data output unit. In addition, the comparator 241-m corresponds to an example of the second comparison unit described in the claims, and the counter 241-m corresponds to an example of the second count unit described in the claims. In addition, for example, the latch function of the counter 242-m corresponds to an example of the second data output unit.

However, for the unitary ADC 240-m, the pixel signal Vx of the corresponding (m)th column is cut off and not input to the comparator 241-m. As shown in the drawings, the temperature signal Vtemp generated by the BGR circuit 270 described below is input to the one input terminal of the comparator 241-m. In addition, the reference signal RAMP is input to the other terminal of the comparator 241 in the same way as those of the unitary ADCs 240-1 to 240-(m−1) of other columns. In this manner, by inputting the temperature signal to the one input terminal of the comparator 241-m, digital temperature data Dt are output from the unitary ADC 240-m.

In addition, hereinafter, in the column ADC unit 230, the unitary ADCs 240-1 to 240-(m−1) outputting the imaging signal data Dv are often referred to as a “imaging unitary ADC.” In addition, the unitary ADC 240-m outputting the temperature data Dt are also referred to as a “temperature unitary ADC.” As a result, the former and latter unitary ADCs are distinguished. In addition, the comparators 241-1 to 241-m and the counters 242-1 to 242-m in the imaging unitary ADCs are often referred to as a “imaging comparator” and “imaging counter,” respectively. In addition, the comparator 241-m and the counter 242-m of the temperature unitary ADC 240-m are often referred to as a “temperature comparator” and a “temperature counter,” respectively.

Furthermore, in the following description, the unitary ADCs 240-1 to 240-m are simply referred to as a unitary ADC 240 unless asked about which one is selected. Similarly, the comparators 241-1 to 241-m and the counters 242-1 to 242-m are simply referred to as a comparator 241 and a counter 242, respectively, unless asked about which one of the unitary ADCs 240-1 to 240-m is selected.

The column scanning circuit 260 includes, for example, a shift register or a decoder similar to the row scanning circuit 220. The column scanning circuit 260 outputs the column control signals in the sequence of each of the counters 242-1 to 242-m of the unitary ADCs 240-1 to 240-m at the timing based on the column (horizontal) scanning timing signal output from the timing control circuit 290. As a result, the column scanning is progressed. The latched count values (imaging signal data Dv and temperature data Dt) are output to the data output line 218 in the sequence of from the counter 242-1 of the unitary ADC 240-1 to the counter 242-m of the unitary ADCs 240-m at the timing of this scanning. In addition, the count value is represented as a predetermined bit number N. The count values of the bit number N output in this manner become imaging signal data Dv (the outputs from the unitary ADCs 240-1 to 240-(m−1) or the temperature data Dt (the output from the unitary ADC 240-m) by converting the pixel signal Vx into a digital format.

Such imaging signal data Dv and the temperature data Dt are output to the external side of the image sensor 103 through the buffer amplifier 280 and, for example, can be input to the signal processing unit 104 as shown in FIG. 1.

The timing control circuit 290 generates a necessary clock, a timing signal, or the like based on the input master clock MCK and outputs them to appropriate portions. For example, the timing control circuit 290 generates the clock CK having a predetermined frequency and outputs it to the reference signal generation circuit 250 and each of the counters 242-1 to 242-m within the unitary ADCs 240-1 to 240-m. In addition, the timing control circuit 290 generates the timing signals TM1 and TM2 outputs them to each of the counters 242-1 to 242-m within the unitary ADCs 240-1 to 240-m. In addition, the timing control circuit 290 generates the timing signal TM3 and outputs it to the reference signal generation circuit 250. In addition, timing control circuit 290 generates the timing signal TM4 for resetting the count value and outputs it to each of the comparators 241-1 to 241-(m−1) of the unitary ADC 240-1 to 240-(m−1) in parallel.

The reference signal generation circuit 250 generates a reference signal RAMP having a ramp waveform with a predetermined inclination at an appropriate timing using the input clock CK and the timing signal TM3. In addition, the reference signal RAMP is output to each of the comparators 241-1 to 241-m within the unitary ADCs 240-1 to 240-m. For example, the timing signal TM3 is used to determine a time period corresponding to the ramp waveform in the reference signal RAMP.

Originally, the BGR circuit 270 is a circuit for outputting the local voltage Vlc using a power voltage VDD (not shown). The local voltage Vlc is a direct current (DC) voltage of a predetermined value that does not change depending on the temperature and is supplied to desired portions of the image sensor 103 as necessary. For example, the local voltage Vlc may be used by the reference signal generation circuit 250 through a signal line (not shown). In this case, the reference signal generation circuit 250 sets the reference value of the reference signal RAMP, for example, using the local voltage Vlc. In addition, although not shown in FIG. 2, in the image sensor 103, a constant current source is connected to each column unit of the pixel 211. However, the circuit for generating the constant current source may set the reference value for generating the constant electric current using the local voltage Vlc.

Furthermore, according to the first embodiment of the invention, the aforementioned BGR circuit 270 is configured to detect the temperature and output an analog temperature signal Vtemp of which voltage value changes depending on the temperature change. The temperature signal Vtemp is input to the one input terminal of the comparator 241-m of the temperature unitary ADC 240-m corresponding to the (m) th column as described above. In addition, the circuit configuration example of the BGR circuit 270 according to the first embodiment of the invention will be described below.

In addition, the BGR circuit 270 corresponds to an example of the local voltage/temperature signal generating unit described in the claims.

### [Configuration Example of Comparator]

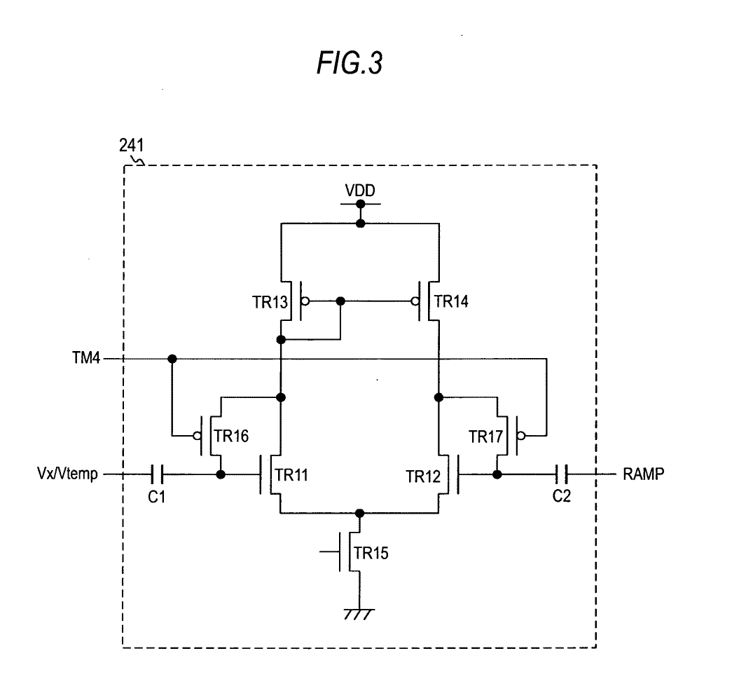

FIG. 3 illustrates a circuit configuration example of the comparator 241. In addition, the configuration shown in this drawing is common to the comparators 241-1 to 241-m. The comparator 241 shown in FIG. 3 includes N-channel input transistors TR11 and TR12, and P-channel transistors TR13 and TR14. In addition, comparator 241 further includes an N-channel current source transistor TR15, P-channel transistors TR16 and TR17, and capacitors C1 and C2.

Each source of the input transistors TR11 and TR12 are commonly connected, and such a connection point is grounded through the drain and the source of the current source transistor TR15. The pixel signal Vx or the temperature signal Vtemp out of the input signal to the comparator 241 is input to the gate of the input transistor TR11 through the capacitor C1, and the reference signal RAMP is input to the gate of the input transistor TR13 through the capacitor C2.

In addition, the drain of the input transistor TR11 is connected to the power voltage VDD through the transistor TR13. The source of the transistor TR13 is connected to the power voltage VDD, and the drain of the transistor TR13 is connected to the source of the transistor TR11. In addition, the drain and the gate of the transistor TR13 are shorted.

Similarly, the drain of the input transistor TR12 is connected to the power voltage VDD through the transistor TR14. The source of the transistor TR14 is connected to the power voltage VDD, and the drain of the transistor TR14 is connected to the source of the transistor TR12.

As recognized from the aforementioned circuit configuration, in the comparator 241, a common current source transistor TR15 is provided between the amplifier circuit of the transistors TR11 and TR13 side and the amplifier circuit of the transistors TR12 and TR14 side symmetric to each other. In other words, a circuit configuration as a differential amplifier for amplifying the pixel signal Vx as an input signal or a difference of the voltage value between the temperature signal Vtemp and the pixel signal Vx is employed.

Furthermore, the comparator 241 is provided with a pair of reset transistors TR16 and TR17. The timing signal TM4 is branched and input to each gate of the transistors TR16 and TR17. In addition, the drain and the source of the transistor TR16 are connected to the drain and the gate of the transistor TR11, respectively. Similarly, the drain and the source of the transistor TR17 are connected to the drain and the gate of the transistor TR12, respectively.

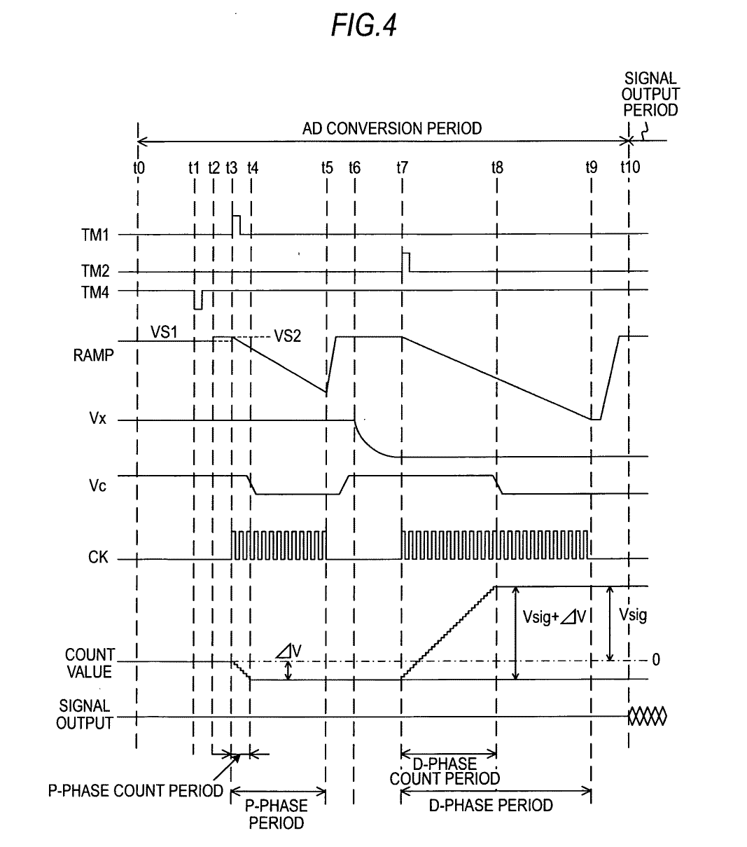

The timing signal TM4 is a signal for outputting a L-level (low active) pulse, for example, at a predetermined timing of the A/D conversion period corresponding to a single horizontal line as described below in conjunction with FIG. 4.

For example, it is assumed that the aforementioned A/D conversion period is initiated, and the comparator 241 reaches the timing at which the electric potential of the column signal line 213 of the input pixel signal Vx and the electric potential of the signal line where the initial voltage of the reference signal RAMP is applied are stabilized. Then, a low active pulse is input as the timing signal TM4. At the output timing of the low active pulse, the reset transistors TR16 and TR17 are simultaneously turned on, and each gate and each drain of the input transistors TR11 and TR12 are shorted. As a result, the operation points of the input transistors TR11 and TR12 are reset to the drain voltage.

Here, each gate voltage of the input transistors TR11 and TR12 which forms a differential amplifier includes a Direct Current (DC) offset component included in each of the pixel signal Vx and the reference voltage RAMP. For example, an offset electric potential caused by variations in threshold values Vth of the input transistors TR11 and TR12 is included. However, since the operation points of the input transistors TR11 and TR12 are reset to the drain electric potential, the aforementioned offset electric potential is nearly cancelled. As a result, the electric potentials of two input terminals of the comparator 241 become nearly the same. In addition, hereinafter, the operation for making the input terminals of the comparator 241 reset to the same electric potential in this manner will be referred to as an “input terminal electric potential reset.” As a result of the input terminal electric potential reset, for example, in the actual operation, it is possible to reduce a time necessary to compare the pixel signal Vx and the reference signal RAMP.

### [Operation Example of Image Sensor]

The timing chart of FIG. 4 illustrates an operation example of the image sensor 103. In addition, herein, description will be made based on each operation of the image unitary ADCs 240-1 to 240-(m−1) which performs A/D conversion for the pixel signal Vx as an original operation of the image sensor 103.

Although detailed description for the operation of the pixel 211 is not provided herein, for example, as noted, it is assumed that the reset operation and the transmission operation are periodically carried out in the pixel 211. As the reset operation, the electric potential of the FD reset to a predetermined electric potential is output to the column signal lines 213-1 to 213-m from each pixel 211 selected by row scanning. As the transmission operation, the electric charges accumulated in the photoelectric conversion element depending on the light-receiving amount are transmitted to the FD unit. As a result, the electric potential corresponding to the light-receiving amount is applied to the column signal lines 213-1 to 213-m from each pixel 211 selected by row scanning. In other words, the pixel signal Vx is output.

Referring to FIG. 4, the A/D conversion period is initiated from each time t0, for example, when it is determined that the exposure period is completed. When the A/D conversion period is initiated, first, the reference signal generation circuit 250 outputs the clamp voltage VS1 as the reference signal RAMP.

Next, for example, it is assumed that the time t1 is reached at which it can be considered that the electric potential obtained in the column signal line 213 and the electric potential of the signal line of the reference signal RAMP are stabilized after the A/D conversion period is initiated at the time t1. Then, the timing control circuit 290 outputs an L-level pulse as the timing signal TM4 to obtain a low active state. Accordingly, as described in conjunction with FIG. 3, two input terminals of the comparator 241 have nearly the same electric potential by virtue of the input terminal electric potential reset.

However, in practice, when the period of the input terminal electric potential reset in the aforementioned comparator 241 is short, or the offset of the input electric potential is perfectly cancelled to obtain nearly the same electric potential, an erroneous operation may occur as described below. Specifically, the output of the comparator 241 may not be inverted even when it had to be inverted, or inversely, may be inverted even when it had not to be inverted. In this regard, according to an embodiment of the invention, the following configuration may be employed. Specifically, for example, at the time t2 elapsing a predetermined time from the execution timing of the input electric potential reset of the time t1, the voltage level of the reference signal RAMP may be changed from the clamp voltage VS1 to the initial voltage VS2. As a result, it is possible to prevent an erroneous operation in the comparator 241 described above.

Here, since the pixel 211 selected as a reading target has a reset operation state before the time t6, an electric potential as a reset component obtained in the FD unit is developed in the column signal line 213. Therefore, before the time t6, the comparator 241 compares each voltage value between the pixel signal Vx of the reset component and the reference signal RAMP and outputs the output signal Vc.

The initial voltage value VS2 as the reference signal RAMP is higher than the voltage value of the reset component obtained as the pixel signal Vx. Accordingly, before the time t3, the output signal Vc of the comparator 241 is outputting the H-level.

The period from the time t3 to the time t5 is set to the P-phase period. A predetermined time length is defined as the P-phase period in advance. In this P-phase period, the timing control circuit 290 generates as the reference signal RAMP a ramp waveform decaying by a predetermined constant inclination as time elapses and outputs it. In addition, at the time t3 corresponding to the initiation timing of the P-phase period, for example, a H-level pulse (P-phase count initiation pulse) is output as the timing signal TM1. In response to the P-phase count initiation pulse, the counter 242 initiates the down-count. In other words, as shown in FIG. 4, the counter 242 initiates the down-count operation starting from the count value 0, for example, at the count timings synchronized with the clock CK from the time t3. In addition, although not shown in the drawings, the count value of the counter 242 is reset to zero at a predetermined timing before the time t3.

In this drawing, at the time t4, the reference signal RAMP of the ramp waveform and the pixel signal Vx input from the comparator 241 are changed such that the voltage value of the reference signal RAMP is lower. In response, the output signal Vc of the comparator 241 is inverted into the L-level from the H-level at the time t4. In addition, the counter 242 is configured to stop the count operation at the timing when the received output signal Vc is inverted. For this reason, the counter 242 stops the down-count at the time t4, that has been initiated from the time t3. Therefore, in this case, the period from the time t3 to the time t4 corresponds to the P-phase count period at which the down-count is actually executed in the P-phase period. In addition, the counter 242 has a latch function so as to store the count value obtained at the end of the down-count in response to stopping the down-count even after the time t4.

As the P-phase count period is completed at the time t5 subsequent to the time t4, the reference signal generation circuit 250 returns the reference signal RAMP, that has decayed due to the ramp waveform until that time, for example, to the initial voltage value VS2. In response, the voltage value of the reference signal RAMP is higher than the voltage value of the pixel signal Vx at timings after the time t5, so that the output signal Vc of the comparator 241 is inverted to the H-level.

In addition, at the timing t6 when a predetermined time elapses after the P-phase count period is terminated, the pixel 211 now advances from the reset operation to the transmission operation. As a result, in the column signal line 213, a voltage value of the light-receiving signal component corresponding to the electric charges accumulated in the photodiode depending on the received light amount is developed.

In addition, at the time t7, the D-phase period is set across a predetermined period to the time t9. During the D-phase period, the reference signal generation circuit 250 initiates the output of the reference signal RAMP again using the ramp waveform. In addition, at the time t7, as the timing signal TM2, for example, a H-level pulse (D-phase count initiation pulse) is output. In response, the counter 242 initiates up-count. This up-count is initiated from the count value stored by the down-count at the previous P-phase count period (t3 to t4).

At the time t7 at which the D-phase count period is initiated, since the voltage value of the reference signal RAMP is higher than the pixel signal Vx, the output signal Vc of the comparator 241 is maintained in the H-level. However, since the reference signal RAMP has a ramp waveform, in this case, at the time t8 after a predetermined time elapses from the time t7, the voltage value of the reference signal RAMP is lower than the voltage value of the pixel signal Vx. As a result, at the timing corresponding to the time t8, the output signal Vc of the comparator 241 is inverted into the L-level.

At the time t8, as the output signal Vc of the comparator 241 is inverted, the counter 242 stops the up-count conducted so far, and after the time t8, stores the count value obtained at this moment of stopping.

Here, the absolute value of the negative count value obtained at the P-phase count period (t3 to t4) represents a level (voltage value) as a reset component Δv. In addition, the positive count value obtained by the up-count of the D-phase count period (t7 to t8) represents a level (voltage value) of the signal component Vsig corresponding to the received light amount. However, the up-count of the D-phase count period is initiated from the count value corresponding to the reset component Δv obtained during the, P-phase count period.

Therefore, the up-count operation of the D-phase count period and the down-count of the P-phase count period executed by the counter 242 are equivalent to the operation represented by the following equation:

(Vsig+ΔV)−Δv=Vsig (1).

In practice, the reset component Δv and the signal component Vsig contain the offset component ΔVofs of the corresponding unitary ADC 240. Therefore, the equation (1) can be modified as follows.

(Vsig+ΔV+ΔVofs)−(Δv+ΔVofs)=Vsig (2)

For example, the reset component ΔV contains a variation component caused by variations in each pixel 211. Therefore, the equation (2) means that the signal Vsig is obtained as an accurate value by canceling the variation component of the voltage value caused by variations in each pixel 211 and the offset component of the unitary ADC 240.

In this manner, the unitary ADC 240 in the column ADC unit 230 executes a Correlated Double Sampling (CDS) as the analog pixel signal Vx is converted into a digital signal. As a result, a higher fidelity signal value can be obtained.

In this case, the A/D conversion period is terminated at the timing after a predetermined time elapses from the time t9 corresponding to a timing for terminating the D-phase period in FIG. 4, and the flow advances to the signal output period. At the signal output period, for example, through the scanning of the column scanning circuit 260, the imaging signal data Dv (signal component Vsig) are sequentially output from each counter 242-1 to 242-(m−1) of the image unitary ADC 240-1 to 240-(m−1) in the column ADC unit 230. In addition, the temperature data Dt generated as described below are output from the (m)th temperature unitary ADC 240-m.

In addition, the P-phase count period corresponds to an example of the count period within the reset period described in the claims, and the D-phase count period corresponds to an example of the count period within the signal period described in the claims.

### [Circuit Configuration Example for Generating Temperature Data]

FIG. 5 selectively illustrates, as a configuration for creating temperature data Dt in the image sensor 103, an internal configuration example of the BGR circuit 270 and a temperature unitary ADC 240-m in the column ADC unit 230.

The BGR circuit 270 shown in FIG. 5 includes P-channel transistors TR1, TR2, and TR3, PNP bipolar transistors Q1, Q2, and Q3, resistors R1 and R2, a switch SW1, an amplifier 271, and a buffer 272.

The emitter of the transistor Q1 is connected to the drain of the transistor TR1 through the resistor R2. The source of the transistor TR1 is connected to the power voltage VDD. The emitter of the transistor Q2 is connected to the power voltage VDD through the transistor TR2. In addition, the emitter of the transistor Q3 is connected to the power voltage VDD through the transistor TR3.

Bases of the transistors Q1, Q2, and Q3 are commonly connected. In addition, the collectors of the transistors Q1, Q2, and Q3 are connected to the ground through the resistor R1. In other words, the collectors of the transistors Q1, Q2, and Q3 are commonly connected.

The amplifier 271 receives the electric potentials at the connection point between the resistor R2 and the transistor TR1 and at the emitter of the transistor Q2, amplifies a difference between the electric potentials, and outputs the amplified difference to the gates of the transistors TR1, TR2, and TR3 so as to be fed back.

Both the ends of the resistor R1 are connected to the switch SW1. The switch SW1 switches such that any one of the terminals tm2 and tm3 is selectively connected to the terminal tm1. In this case, the terminal tm2 is connected to the resistor R1 and the connection point of the collectors of the transistors Q1, Q2, and Q3 so that the terminal tm3 is connected to the ground. The terminal tm1 is connected to the input terminal of the buffer 272. In this case, since the signal output from the temperature detection unit 273 through the switch SW1 has high impedance, the signal is converted and output with low impedance by amplification using the buffer 272. In the relationship with FIG. 2, the output from the buffer 272 becomes the temperature signal Vtemp and is input to the temperature unitary ADC 240-m.

In the configuration of the BGR circuit 270 described above, first, a circuit portion including the transistors TR1, TR2, and TR3, transistors Q1, Q2, and Q3, resistors R1 and R2, and an amplifier 271 forms a so-called multiple output type current mirror circuit.

The local voltage Vlc is extracted from the emitter of the transistor Q3. Subsequently, as described below, the voltage VPTAT obtained at the connection point of the collectors of the transistors Q1, Q2, and Q3 has a positive temperature coefficient. On the contrary, for example, the electric potential obtained when an electric current flows through the diode connection (pn junction) of the bipolar transistor Q3 has a negative temperature coefficient. Therefore, in the local voltage Vlc, variations in the voltage value caused by the temperature are cancelled, and a constant voltage that does not change depending on the temperature is provided.

Next, referring to FIG. 5, a circuit unit including transistors TR1 and TR2, transistors Q1 and Q2, and resistors R1 and R2, that is, a circuit in which the transistors TR3 and Q3 for outputting the local voltage Vlc are removed serves as a temperature detection unit 273 for detecting the temperature. In the temperature detection unit 273, the transistors Q1 and Q2 are connected as described above to form a fundamental type of the BGR circuit.

In this temperature detection unit 273, the voltage VPTAT (PTAT: Proportional To Absolute Temperature) can be obtained at the connection point between the collectors of the transistors Q1 and Q2 (and the transistor Q3). The value of the voltage VPTAT changes depending on the temperature change to provide a positive temperature coefficient and can be expressed as follows.

VPTAT=2R2/R1*VT*ln K (3)

In addition, in the aforementioned equation (3), the reference symbol VT denotes a thermal voltage, the reference symbol ln denotes a natural logarithm, and the reference symbol K denotes an emitter area ratio between the bipolar transistors Q1 and Q2.

The voltage VPTAT obtained in this manner corresponds to the detected temperature. The BGR circuit 270 having the temperature detection unit 273 is included in the image sensor 103 as shown in FIG. 2, and the portions included in the image sensor 103 are formed, for example, on the same single IC chip. Therefore, it can be said that the temperature detected by the temperature detection unit 273 represents the temperature of the image sensor 103.

The switch SW1 switches between a state that the terminals tm1 and tm2 are connected at the timing described below, for example, in response to a predetermined timing signal from the timing control circuit 290 and a state that the terminals tm1 and tm3 are connected. When the terminals tm1 and tm2 are connected, a voltage value corresponding to the voltage VPTAT is output through the buffer 272 from the switch SW1. In addition, when the terminals tm1 and tm3 are connected, a voltage value corresponding to a ground voltage is output through the buffer 272 from the switch SW1. In other words, the temperature signal Vtemp according to the embodiment of the invention is a signal capable of switching the voltage value between the voltage VPTAT and the ground level.

As shown in FIG. 5, the temperature signal Vtemp from the BGR circuit 270 is input to the one input terminal of the temperature comparator 241-m in the temperature unitary ADC 240-m. In addition, similar to other image comparators 241-1 to 241-(m−1), the reference signal RAMP is branched and input to the other input terminal of the comparator 241-m.

As described in conjunction with FIG. 2, the timing signal TM4 is commonly input to the temperature comparator 241-m together with the image comparators 241-1 to 241-(m−1). As a result, even for the temperature comparator 241-m, the operation of resetting two input terminals to the same electric potential is carried out at the timing of the time t1 of FIG. 4.

In addition, the same timing signals TM1 and TM2 as those input to the image counters 242-1 to 242-(m−1) are also branched and input to the temperature counter 242-m. As a result, the start points of the up-count and the down-count of the temperature counter 242-m are set to the same points as those of the image counters 242-1 to 242-(m−1). In addition, similar to the image counters 242-1 to 242-(m−1), the column control signal of the corresponding column is input to the temperature counter 242-m from the column scanning circuit 260. As a result, similar to the image counters 242-1 to 242-(m−1), the temperature counter 242-m outputs the latched count value in response to receiving the column control signal.

In other words, the configuration of the temperature unitary ADC 240-m is different from that of the image ADC 240-1 to 240-(m−1) in that the temperature signal Vtemp is input to the one input terminal of the comparator 241-m instead of the pixel signal Vx. As described above, the configuration and the operation itself of the temperature unitary ADC 240-m are similar to, for example, those of the image unitary ADCs 240-1 to 240-(m−1) described in conjunction with FIG. 4. However, the output of the temperature unitary ADC 240-m becomes the temperature data Dt that can be considered as those obtained by digitally converting the voltage VPTAT rather than the imaging signal data Dv.

### [Configuration Example of Temperature Unitary ADC]

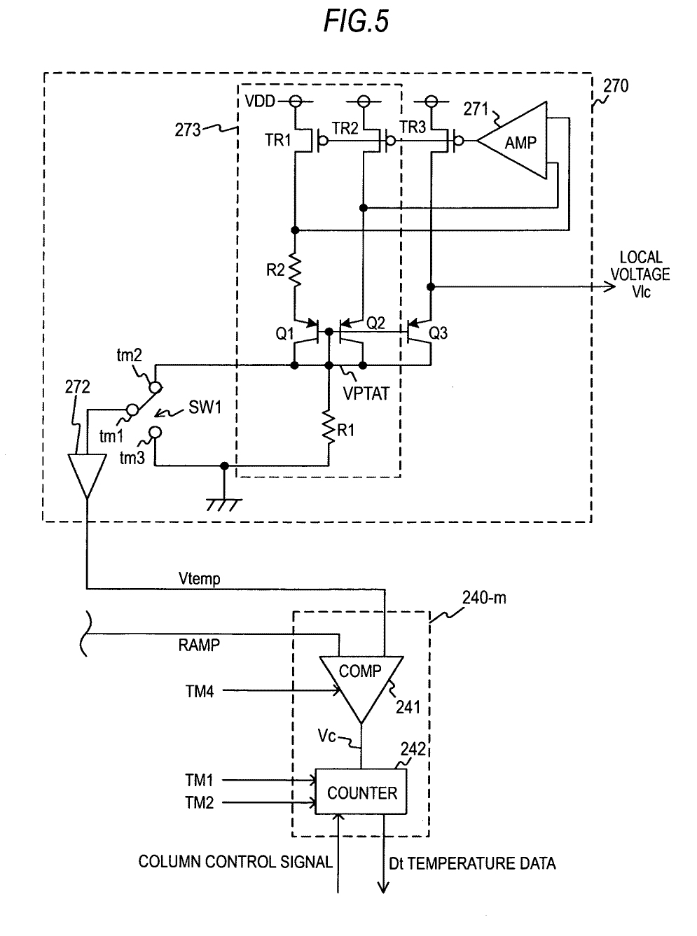

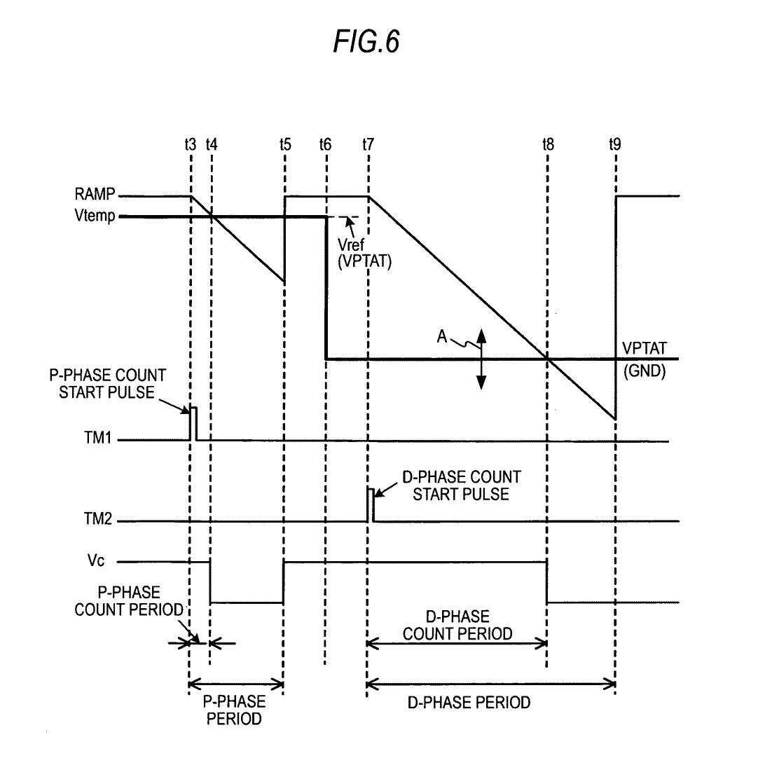

FIG. 6 is a timing chart illustrating the operation of the temperature unitary ADC 240-m. In addition, in FIG. 6, the times t3, t4, t5, t6, t7, and t9 correspond to the times shown in FIG. 4.

Referring to FIG. 6, the operations from the time t3 are shown. The time t3 is timing for initiating the P-phase period, and the reference signal RAMP starts to be decayed with a constant inclination from the initial voltage value VS2. Here, while the temperature signal Vtemp is set to a reference electric potential Vref during the period reaching the time t3, the reference electric potential Vref is maintained until the time t6 is reached after the P-phase period elapses from the time t3. In other words, during the time t3 to t5 corresponding to the P-phase period, the temperature signal Vtemp is set to be capable of reliably obtaining the reference electric potential Vref.

In addition, when the aforementioned reference electric potential Vref is set, the terminals tm1 and tm2 are actually connected to the switch SW1 of the BGR circuit 270 so that the voltage VPTAT is output as the temperature signal Vtemp.

In addition, at the time t3, the P-phase count start pulse rises as the timing signal TM1. In response, similar to other image counters 242-1 to 242-(m−1), the temperature counter 242-m initiates the down-count from the count value 0. In addition, here, it is assumed that the count value obtained by carrying out the down-count from the count 0 has a negative value.

The voltage value of the voltage VPTAT is set to be lower than the initial voltage value VS2 of the reference signal RAMP in consideration of a variation width caused by the temperature. In addition, after the time t3, the voltage value of the reference signal RAMP is gradually reduced due to the ramp waveform. For example, at the time t4 elapsing a predetermined time from the time t3, the voltage VPTAT is changed to be higher than the reference signal RAMP. In response, the output signal Vc of the temperature comparator 241-m is inverted from the H-level to the L-level, and the temperature counter 242-m stops the count operation so as to store the count value obtained by the down-count so far.

The P-phase period is completed at the time t5. At the time t5, the reference signal RAMP is returned to, for example, the initial voltage value VS2. In response, the output signal Vc of the temperature comparator 241-m is inverted into the H-level.

Next, at the time t6 before a predetermined time from the time t7 at which the D-phase period is initiated, the temperature signal Vtemp switches to the electric potential state which changes depending on the temperature and can be recognized as the voltage VPTAT.

However, at the time t6, control is carried out from the state in which the terminals tm1 and tm2 are connected to the switch SW1 of the BGR circuit 270 to the state in which the terminals tm1 and tm3 are connected to the switch SW1. In other words, in practice, the temperature signal Vtemp has a ground (GND) level after the time t6.

However, for example, as described above in conjunction with FIGS. 3 and 4, in the actual temperature comparator 241-m, an operation for resetting two input terminals to the same electric potential is carried out at the time t1 before the time t3. For this reason, in the P-phase period, the voltage VPTAT output as the temperature signal Vtemp is set to a reference electric potential Vref. As a result, as seen from the temperature comparator 241-m, the ground electric potential output as the temperature signal Vtemp during the D-phase period is handled such that the electric potential changes depending on the temperature as indicated by the arrow A of FIG. 6. In other words, although a ground electric potential is input as the temperature signal Vtemp in practice after the time t6, it is necessary to treat the temperature signal Vtemp as the voltage VPTAT that changes depending on the temperature.

At the time t7 at which the temperature signal Vtemp switched to the ground electric potential at the time t6 is considered to be stabilized, the D-phase period is initiated. At the time t7 corresponding to the start timing of the D-phase period, the reference signal RAMP starts to decrease with a constant inclination. In addition, at the time t7, the D-phase count start pulse rises as the timing signal TM2. In response, the temperature counter 242-m initiates the up-count simultaneously with other image counters 242-1 to 242-(m−1).

In this case, at the time t8, the reference signal RAMP has a level equal to or lower than the temperature signal Vtemp, and the output signal Vc of the temperature comparator 241-m is inverted to the L-level. In response, the temperature counter 242-m stops the up-count so far and stores the count value. As a result, the D-phase count period is completed. The temperature counter 242-m outputs the count value obtained in the D-phase count period to the data output line 281 as the temperature data Dt at the timing at which the column control signal is input from the column scanning circuit 260.

Then, as it is considered that the time t9 at which the D-phase period is completed is reached, for example, the reference signal RAMP is returned to the initial voltage value again.

In this manner, while the temperature unitary ADC 240 compares the reference signal RAMP and the temperature signal Vtemp using the temperature comparator 241-m, it is understood that the operation itself is similar to those of the image unitary ADCs 240-1 to 240-(m−1). In the temperature unitary ADC 240 that operates in this manner, first, the temperature counter 242-m carries out the down-count during the P-phase count period (time t3 to t4). The count value obtained by the down-count is obtained to match with the reference electric potential Vref and corresponds to the reset component Δv of FIG. 4. Next, the count value obtained by carrying out the up-count using the D-phase count period represents the value of the voltage VPTAT that changes depending on the temperature. This corresponds to the signal component Vsig of FIG. 4. For example, in practice, in the BGR circuit 270, there are an offset component corresponding to a variation in the circuit for outputting the temperature signal Vtemp, and an offset component of the temperature ADC 240-m. However, according to the equations 1 and 2, it is possible to obtain accurate values of the temperature data Dt in which the aforementioned offset components are cancelled by the operation of the CDS. For example, in the case where the BGR circuit 270 is provided with a buffer 272 for converting impedance, similar to the example of FIG. 5, as a circuit for outputting the temperature signal Vtemp, an offset corresponding to the output signal (temperature signal Vtemp) is generated. However, such an offset component can also be sufficiently cancelled using the operation of the CDS in the temperature unitary ADC 240.

According to an embodiment of the invention, the A/D conversion of the temperature signal Vtemp is carried out using the unitary ADC 240-m within the column ADC unit 230. In other words, the portion for carrying out the A/D conversion of the pixel signal Vx in the image sensor 103 is used for the A/D conversion of the temperature information. As recognized from the aforementioned description, the temperature unitary ADC 240-m itself has a similar configuration to that of the image unitary ADC 240-1 to 240-(m−1), differing in that the temperature signal Vtemp is input instead of the pixel signal Vx. In addition, the temperature signal Vtemp is also used as a circuit for generating the original local voltage Vlc in the image sensor 103.

For example, as another configuration, the ADC for outputting the temperature data may be provided separately from the column ADC unit 230. However, in this case, a circuit size increases accordingly. On the contrary, the configuration for outputting the temperature information according to the embodiment of the invention can be implemented with little change without a separate circuit added to the current configuration of the image sensor. As a result, for example, it is possible to prevent the size of the IC chip as the image sensor 103 from increasing, simplify a manufacturing process, or reduce cost. In addition, using the unitary ADC 240 within the column ADC unit 230, the offset components are cancelled and stabilized due to the operation of the CDS. Therefore, it is possible to readily obtain data representing the accurate temperature.

[Relationship Example between Temperature Unitary ADC and Area within Pixel Array]

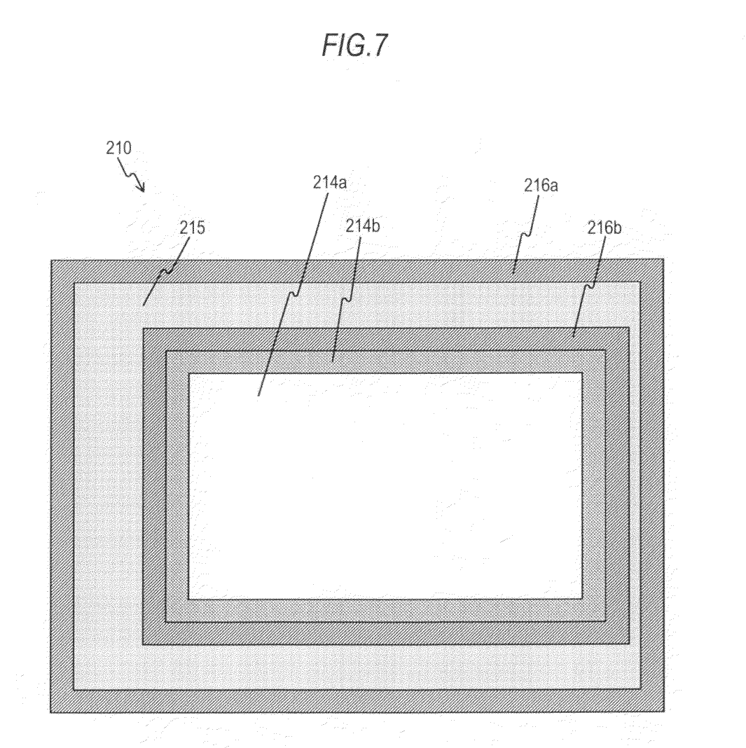

FIG. 7 illustrates an example of area distribution set in the pixel array 210. As shown in FIG. 7, the plane area as the pixel array 210 is divided into an effective pixel area 214a, an effective pixel unrelated area 214b, an Optical Black (OPB) area 215, and OPB unrelated areas 216a and 216b. Although not shown in the drawings, the pixel array 210 is arranged in a matrix shape having n rows×m columns of pixels 211 as shown in FIG. 2. Such pixels 211 are included in any one of the effective pixel area 214a, the effective pixel unrelated area 214b, the OPB area 215, and the OPB unrelated areas 216a and 216b depending on the arrangement position on the pixel array 210.

In the example of FIG. 7, the effective pixel area 214a is provided in the centermost side of the pixel array 210, and the effective pixel unrelated area 214b is provided in the outer periphery. In addition, the OPB unrelated area 216b is provided in the outer periphery thereof, and the OPB area 215 is provided in the further outer periphery. In addition, another OPB unrelated area 216a is provided in the still further outer side of the OPB area 215 and the outermost periphery. In addition, various other arrangement patterns may be used for the effective pixel area, the OPB area, and the OPB unrelated area.

The effective pixel area 214a is an area including the effective pixel. The effective pixel refers to a pixel out of the pixels 211 in the pixel array 210, in which a pixel signal Vx obtained therefrom is effectively used as actual image data. The effective pixel area 214a is provided, for example, in the centermost side of the pixel array 210 as shown in drawings.

The OPB area 215 is an area provided to set the reference of a black level. The pixel in the OPB area 215 is optically shielded and thus capable of outputting the pixel signal Vx having a voltage value corresponding to a reference black level. Therefore, the pixel signal Vx from the pixel 211 of the OPB area 215 is not effectively and directly used as practical image, but used in the image signal processing to set the reference black level.

However, in the OPB area 215, leakage light from the external side exists in the pixels positioned near a boundary with other areas such as pixels located in the inner periphery or the outer periphery thereof. For this reason, electric charges corresponding to the received light amount that much are accumulated, and the appropriate pixel signal Vx may not be output depending on the black level. In this regard, the OPB unrelated areas 216a and 216b are established as a margin in the outer and inner peripheries of the OPB area 215. In addition, the effective pixel unrelated area 214b is also provided as a buffer area between the effective pixel area 214a and the OPB area 215. The pixels 211 provided in such OPB unrelated areas 216a and 216b and the effective pixel unrelated area 214b are perfectly ineffective pixels that are not used in the image signal processing.

In addition, the OPB unrelated area 216b corresponds to an example of the image processing unrelated area described in the claims.

Meanwhile, as shown in FIG. 2, in the pixel array 210, the row of pixels including the pixels 211 connected to the column signal line 213-m originally matches with the temperature unitary ADC 240-m. However, this column signal line 213-m is cut off and incapable of outputting the pixel signal Vx. Then, if the row of pixels corresponding to the temperature unitary ADC 240-m is included in the effective pixel area 214, it causes a problem that the image portion corresponding to that single row is missed.

In addition, it is assumed that the row of pixels corresponding to the temperature unitary ADC 240-m is used as the row of pixels connected to the column signal line 213 passing through the OPB area 215. In this case, the pixel signal Vx corresponding to the black level may not be extracted from the row of pixels corresponding to the temperature unitary ADC 240-m. For this reason, there is a probability that some problems may occur regarding the black level setting.

In this regard, according to an embodiment of the invention, the row of pixels corresponding to the temperature unitary ADC 240-m is selected from the rows of pixels included in the effective pixel unrelated area 214b. Originally, it is not assumed that the pixels included in the effective pixel unrelated area 214b are used in the image processing as described above. Therefore, if they match with the temperature unitary ADC 240-m, there is no problem, and it is optimal.

In addition, since the effective pixel unrelated area 214b is established in the outer periphery of the effective pixel area 214a, all pixels from the first to (n) th rows used to form the row of pixels matching with the temperature unitary ADC 240-m are included in the effective pixel unrelated area 214b. Then, the temperature unitary ADC 240-m can obtain the temperature data Dt by carrying out the A/D conversion for the temperature signal Vtemp whenever the first to (n) th rows of the pixel array 210 are sequentially scanned for a single frame. In other words, according to an embodiment of the invention, for a single frame, n pieces of temperature data Dt corresponding to the number of rows in the pixel array 210 can be obtained at a maximum.

As recognized from the aforementioned description, according to an embodiment of the invention, it is possible to obtain a single piece of the temperature data Dt whenever a single row of the pixel array 210 is scanned. In other words, it is possible to obtain a single piece of temperature data Dt simultaneously with image data corresponding to a single line in every row scanning timing. In addition, it is possible to obtain n pieces of temperature data Dt at a maximum simultaneously with the image data corresponding to a single frame. In other words, according to an embodiment of the invention, it is possible to real-timely obtain temperature data simultaneously with the image data. For example, in order to realize such a real-time property using other ADC configurations, a number of additional circuits are necessary.

In addition, according to an embodiment of the invention, for example, maximum n pieces of temperature data Dt obtained for a single frame are integrated or averaged, and the result is treated as temperature information corresponding to a single frame period. As a result, for example, compared to a case where any one of n pieces of temperature data Dt obtained for a single frame is sampled and used as temperature information, it is possible to obtain high precision.

### [Exemplary Process of Obtaining Frame Period-related Temperature Data]

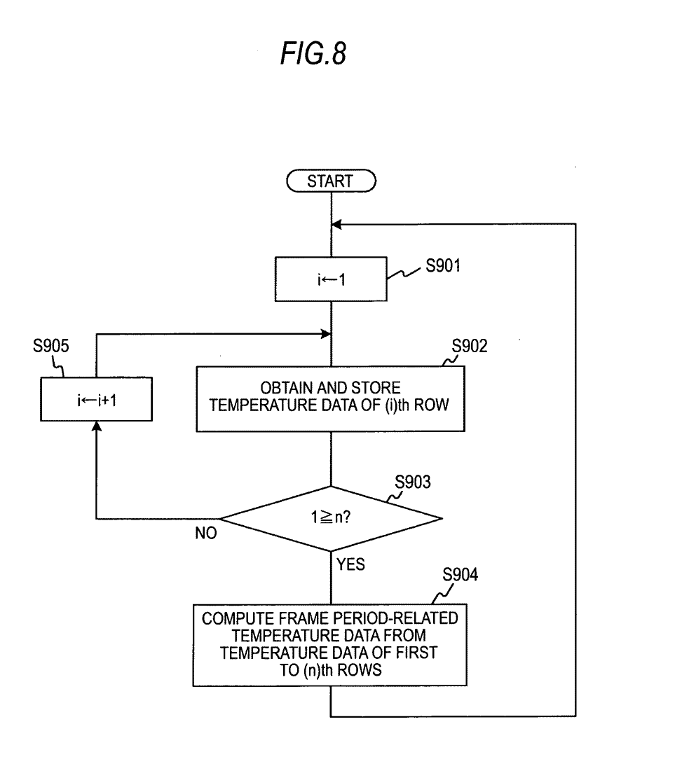

FIG. 8 is a flowchart illustrating an exemplary processing sequence for obtaining temperature information for a single frame period described above. The processing sequence shown in FIG. 8 can be regarded as a process implemented, for example, in a Digital Signal Processor (DSP) constituting the signal processing unit 104 by executing a program. Alternatively, the processing sequence may be regarded as a process implemented in the control unit 108 by executing a program. When the control unit 108 executes the process shown in FIG. 8, for example, the temperature data Dt output from the image sensor 103 are received through the signal processing unit 104 unlike the configuration of FIG. 1.

In FIG. 8, first, an initial value of 1 is assigned to the variable i representing a row number in the pixel array 210 (step S901). Then, the temperature data Dt obtained through scanning of the (i)th row and output from the image sensor 103 are received and stored (step S902).

Subsequently, it is determined whether or not the current variable i is equal to or larger than the number n corresponding to a total row number of the pixel array 210 (step S903). In addition, if it is determined that the variable i is not equal to or larger than the row number n, a row for which scanning has not been carried out still exists in a single frame. Therefore, the variable i is incremented (step S905), and the process returns to step S902. On the contrary, in the case where it is determined that the variable i is equal to or larger than the row number n, the scanning has been completed for the first to the (n)th rows of a single frame, and n pieces of temperature data Dt corresponding to the first to the (n)th rows are stored. In this case, frame period-related temperature data are computed using n pieces of temperature data Dt corresponding to the first to the (n) th rows (step S904). In other words, for example, integration or averaging for n pieces of temperature data Dt corresponding to the first to the (n) th rows is carried out. After the step S904, the process returns to step S901 and advances to a process for the next frame.

### [Exemplary Correction Process Using Temperature Information]

In this manner, the frame period-related temperature data obtained by the signal processing unit 104 or the control unit 108 can be used in an appropriate correction process.

For example, the image sensor suffers a leakage phenomenon in which the signal charge stored in the pixel leaks to the signal line side as a dark current. The dark current component causes image degradation. In this regard, a process for removing the dark current is carried out. In this case, it is appreciated that the amount of the dark current varies depending on the temperature. In this regard, the imaging apparatus 100 according to the embodiment of the invention may be configured to correct the amount of the dark current detected depending on the temperature represented by the frame period-related temperature data and carry out a process of reducing the dark current.

In addition, in the process of correcting the defected pixel, for example, it may be determined whether or not the detected pixel is based on the level of the pixel signal Vx. However, the level of the pixel signal Vx in this case also varies depending on the temperature. In this regard, in order to correct the defected pixel using the imaging apparatus 100 according to the embodiment of the invention, it is conceived that the signal level is corrected depending on the temperature represented by the frame period-related temperature data, and determination on the defected pixel is carried out.

As described above, the frame period-related temperature data have a real-time property, for example, in each frame period. Therefore, for example, in the signal processing such as a process of reducing the dark current and a process of correcting the pixel defect, the signal processing can be carried out to follow actual temperature change at that time using the temperature data corresponding to the frame period. As a result, for example, it is possible to reduce a high dark current and correct the defected pixel.

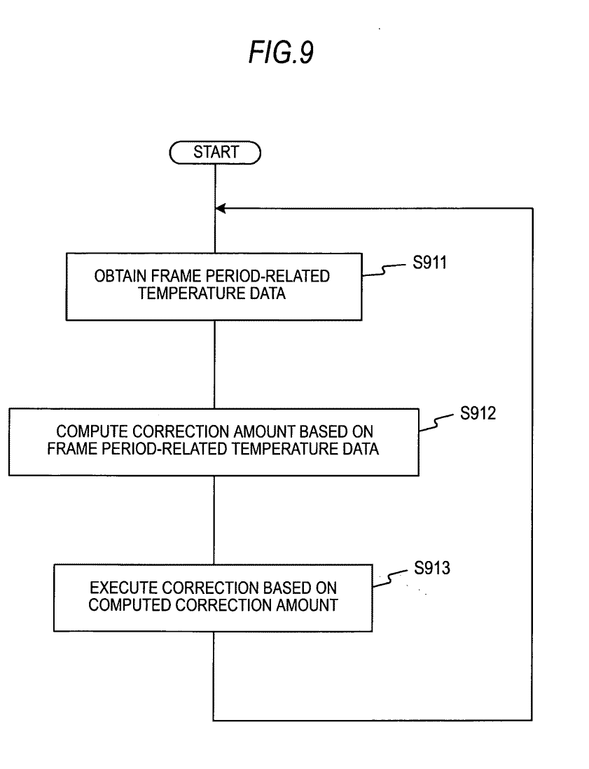

FIG. 9 is a flowchart illustrating an exemplary correction processing sequence using the frame period-related temperature data. The process shown in FIG. 9 also can be considered as a sequence obtained by executing a program using a signal processing unit 104 as a DSP.

In FIG. 9, first, the frame period-related temperature data for a frame period corresponding to the current time point are obtained (step S911). The process of this step S911 corresponds to, for example, a single process of steps S901 to S905 shown in FIG. 8. Then, using the obtained frame period-related temperature data, a correction amount (correction parameter) is computed (step S912). In addition, correction for a predetermined parameter is carried out based on the computed correction amount (step S913). For example, in the case of a process of reducing the dark current, the detected dark current value is corrected. In the case of a process of correcting a defected pixel, for example, the signal level for determining a defected pixel (or a threshold value compared with the signal line) is corrected.

In addition, while the frame period-related temperature data described above or the temperature data for a predetermined unitary period are obtained for each single frame period, the temperature data may be obtained, for example, for two or more consecutive frame periods. Alternatively, the temperature data may be obtained for a predetermined period shorter than a single frame.

### 2. Second Embodiment

### [Example of Gain Change]

The imaging apparatus 100 according to the embodiment of the invention may be provided with a function capable of changing the gain for the image data (signal) read from the image sensor 103. The second embodiment provides an image sensor 103 configured to obtain suitable temperature information for the case that the imaging apparatus 100 employs such a variable gain configuration.

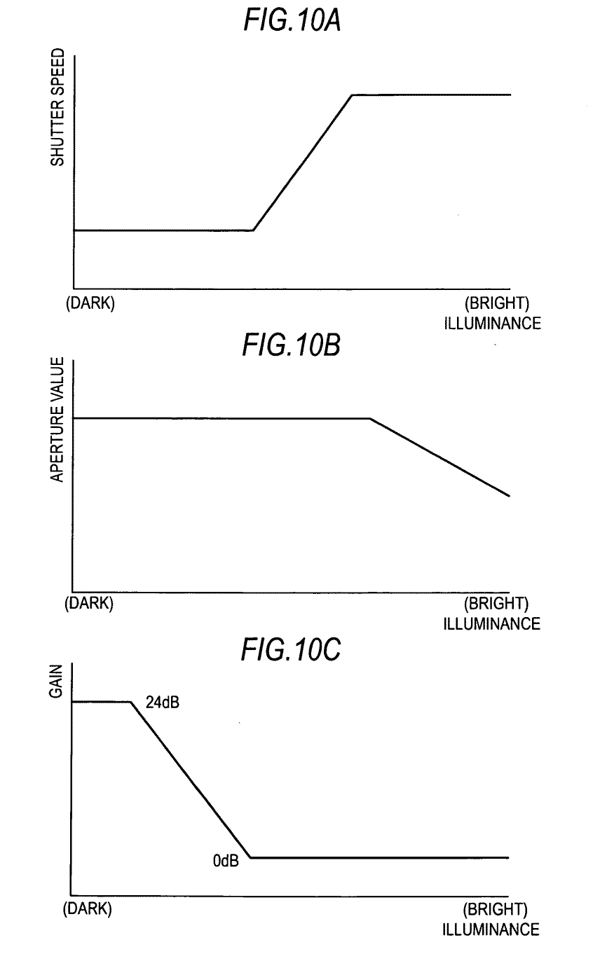

First, an example of gain change for the image data executed by the imaging apparatus 100 will be described with reference to FIGS. 10A to 10C.

As the imaging apparatus 100 performs automatic exposure (AE) control, first, the illuminance detection unit 114 detects illuminance, and the control unit 108 specifies, for example, a shutter speed and an aperture value based on the detected illuminance and performs control to provide the shutter speed and the aperture value specified above. It is noted that, as the shutter speed becomes lower, the received light amount increases in the image sensor 103, and the imaging signal level increases so as to obtain a brighter image. In addition, as the aperture value increases, the opening size of the aperture 122 increases, and the amount of light incident to the image sensor 103 increases so as to obtain a higher imaging signal level.

Furthermore, in the AE control, a parameter of the gain for the imaging signal data is determined. As the imaging signal data increase by raising the gain, the brighter captured image can be obtained that much. In the AE control, depending on the detected illuminance, respective parameters of the shutter speed, the aperture value, and the gain are changed to appropriate values. In addition, exposure suitable for illuminance can be obtained based on a combination of such parameters.

Here, the change control of the shutter speed and the aperture value is carried out, for example, by allowing the control unit 108 to control the shutter driving unit 110 and the aperture driving unit 111. In addition, the gain can change by allowing the control unit 108 to control the gain setting unit 109 such that the gain setting unit 109 specifies the gain for the image sensor 103.

In addition, the process of allowing the control unit 108 to specify the gain based on the illuminance as a process relating to the AE control described above corresponds to an example of the gain specifying unit described in the claims.

FIGS. 10A, 10B, and 10C schematically illustrate examples of changing the shutter speed, the aperture value, and the gain based on the detected illuminance, respectively. Referring to FIGS. 10A, 10B, and 10C, the shutter speed shown in FIG. 10A is changed to be higher as the illuminance increases. In addition, the aperture value is modified to be smaller, in other words, to provide a smaller opening size in the higher illuminance area. Furthermore, while the gain becomes 0 dB (the gain scale factor: 1) in a certain or higher illuminance range, the gain is changed to gradually increase if the illuminance is reduced to be lower than that. In addition, if the illuminance is further reduced, the maximum gain (here, 24 dB (gain scale factor: 16)) is set.

FIGS. 10A, 10B, and 10C schematically illustrate the trends of variation of the shutter speed, the aperture value, and the gain in the AE control. In practice, each parameter is more strictly specified based on the illuminance. For example, in the areas where the shutter speed, the aperture value, and the gain vary with an inclination in FIGS. 10A, 10B, and 10C, they vary step by step rather than linearly in practice.

### [Exemplary Process of Gain Change]

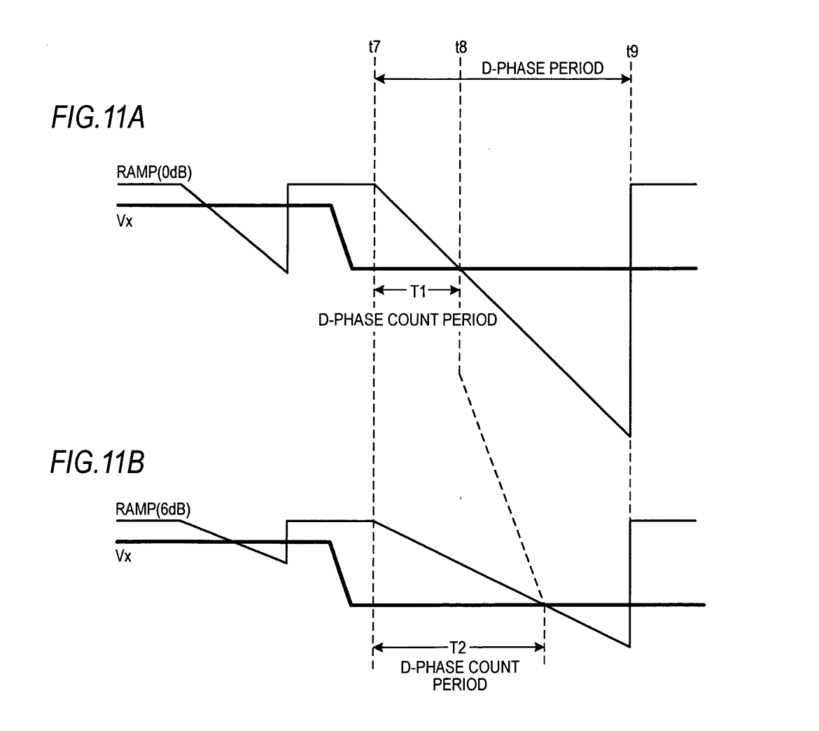

As recognized from the aforementioned description, the image sensor 103 according to the embodiment of the invention carries out the A/D conversion using the column ADC unit 230 based on a CDS technique. According to the second embodiment of the invention, the gain applied to the pixel signal Vx is changed using this A/D conversion configuration. An example of such gain change process will be described with reference to FIGS. 11A and 11B.

First, the timing charts of FIGS. 11A and 11B illustrate the reference signal RAMP and pixel signal Vx input to the image comparators 241-1 to 241-(m−1) in a single image unitary ADC. In addition, the reference signal RAMP shown in FIG. 11A corresponds to the gain value of 0 dB. In other words, the gain scale factor is set to 1 so as to provide a state that no gain is applied substantially.

Here, in FIG. 11A, focusing on the D-phase period from the time t7 to the time t9, the D-phase period is a period capable of executing the up-count using the counter 242, and the reference signal RAMP in this period decreases as time elapses due to the ramp waveform. At this moment, the time length of the D-phase count period represented as a period from the time t7 to the time t8 is defined by the inclination of the ramp waveform of the reference signal RAMP and the signal level of the pixel signal Vx. Here, the time length of the D-phase count period obtained in FIG. 11A is represented by the reference numeral T1.

Next, the waveform diagram of FIG. 11B illustrates an example in which the gain is set to 6 dB. In other words, FIG. 11B shows an example of setting a gain scale factor two times of the gain of 0 dB of FIG. 11A. In addition, for the purpose of comparison with FIG. 11A, FIG. 11B shows the same waveform of the pixel signal Vx as that of FIG. 11A. In the case where a gain of 6 dB is set in this manner, as indicated by the D-phase period (t7 to t9) of the reference signal RAMP in FIG. 11B, the ramp waveform has a smaller inclination than that of FIG. 11A. Accordingly, a predetermined inclination of about ½ of the ramp waveform of FIG. 11A is set as the inclination of the ramp waveform of the reference signal RAMP of FIG. 11B. Furthermore, the change of inclination of the ramp waveform in such a reference signal RAMP may be implemented by changing the electric current value in the circuit unit for generating the ramp waveform, for example, in the reference signal generation circuit 250.

In this manner, by changing the inclination of the ramp waveform of the reference signal RAMP, the time period from the starting point of the D-phase period of the time t7 to when the level of the reference signal RAMP becomes smaller than the pixel signal Vx is lengthened in comparison with the case of FIG. 11A. Specifically, the time length T2 as the D-phase count period is, for example, double the time length T1 of FIG. 11A. As a result, the level of the imaging signal data Dv obtained by carrying out A/D conversion for the pixel signal Vx having the same amplitude with a gain of 6 dB increases approximately double the case of 0 dB. In other words, the gain applied to the imaging signal data Dv becomes double. In this manner, according to an embodiment of the invention, the gain change is implemented by changing the inclination applied to the ramp waveform of the reference signal RAMP based on the gain to be set.

However, the following problems may occur when the process of changing the gain described in conjunction with FIGS. 11A and 11B is directly combined with the configuration for creating the temperature data Dt according to the first embodiment of the invention described in conjunction with FIG. 5.

Here, first, it is assumed that the reference signal RAMP of FIG. 6 has an inclination corresponding to the case where a gain of 0 dB is set. In this case, as indicated by the time t8 in FIG. 6, the timing when the level of the reference signal RAMP becomes equal to or lower than the temperature signal Vtemp in the D-phase period (t7 to t9) is normally obtained. In other words, the temperature counter 242-m normally completes the up-count operation in the D-phase period (t7 to t9).

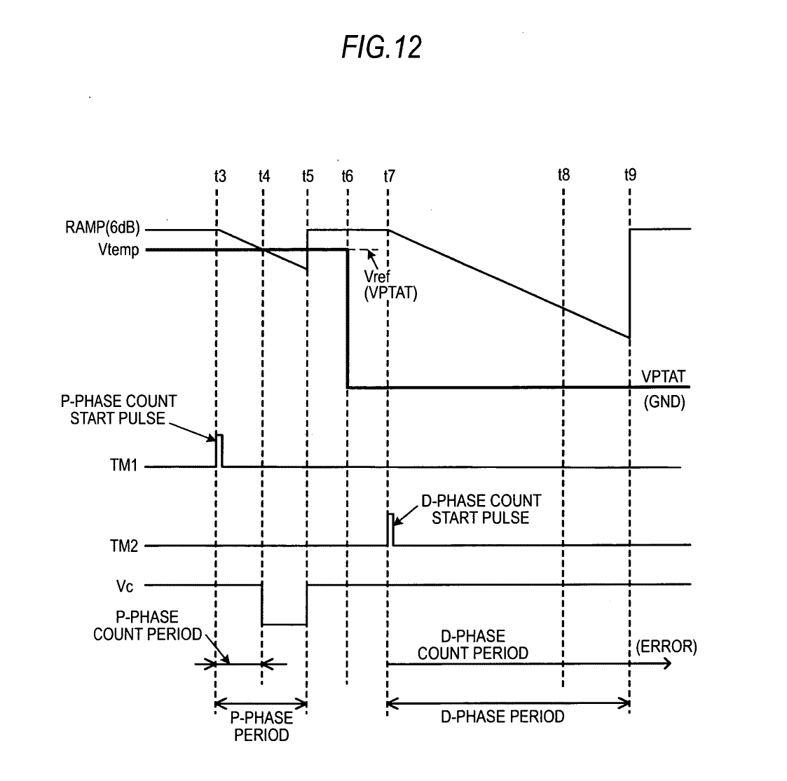

Next, FIG. 12 is a timing chart illustrating a waveform of the reference signal RAMP generated by applying a gain of 6 dB is illustrated. Specifically, the inclination of the ramp waveform is reduced up to about a half that of the reference signal RAMP of FIG. 6. In addition, the temperature signal Vtemp of FIG. 12 is generated from the BGR circuit 270 of FIG. 5 and is similar to that shown in FIG. 6.

Referring to FIG. 12, since the inclination of the reference signal RAMP is reduced, the following operation is generated. Specifically, for example, even when the time t8 at which the D-phase count period is completed in FIG. 6 elapses, and the time t9 for terminating the D-phase period is reached, the level of the reference signal RAMP is maintained to be higher than the temperature signal Vtemp. For this reason, it is not possible to invert the output signal Vc of the temperature comparator 241-m into the L-level in the D-phase period (t7 to t9) and the temperature counter 242-m is not able to terminate the up-count within the D-phase period even at the time t7. In other words, there is an error that the D-phase count period is not terminated even after the D-phase period elapses. When such an error occurs, it is not possible to output appropriate temperature data Dt from the temperature ADC 240-m based on the original voltage VPTAT.

In this regard, according to the second embodiment of the invention, when a configuration that the gain of the imaging signal is variable is employed, a configuration for constantly obtaining appropriate temperature data Dt based on the changed gain is employed.

### [Exemplary Configuration of BGR Circuit Corresponding to Variable Gain Configuration]

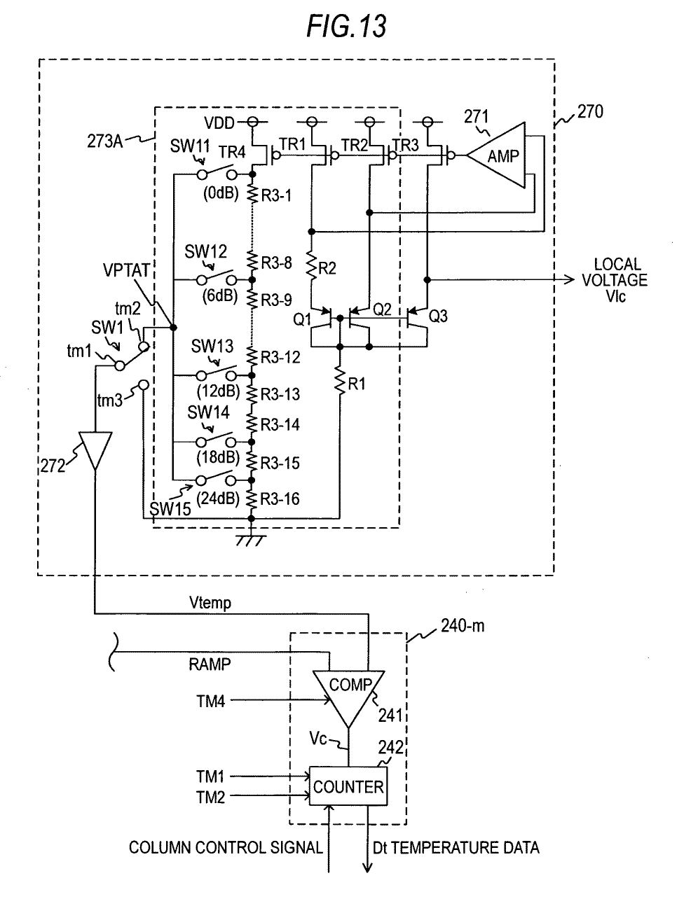

FIG. 13 illustrates an exemplary configuration for outputting the temperature data Dt based on a variable gain according to the second embodiment of the invention. In addition, like reference numerals denote like elements as in FIG. 5, and description thereof will not be repeated.

In the description of FIG. 13, it is assumed that the gain can change in five stages including 0 dB, 6 dB, 12 dB, 18 dB, and 24 dB. Therefore, the reference signal RAMP has a different inclination of the ramp waveform for each of the gains 0 dB, 6 dB, 12 dB, 18 dB, and 24 dB as described below. In addition, the gain scale factor is set to 1 for 0 dB, 2 for 6 dB, 4 for 12 dB, 8 for 18 dB, and 16 for 24 dB.

In FIG. 13, the temperature detection unit 273A within the BGR circuit 270 further includes a transistor TR4, resistors R3-1 to R3-16, and switches SW11, SW12, SW13, SW14, and SW15 in addition to the configuration of the temperature detection unit 273 of FIG. 5. The switches SW11 to SW15 are on/off switches.

Similar to transistors TR1, TR2, and TR3, the transistor TR4 is a P-channel MOS transistor, of which a source is connected to the power voltage VDD. In addition, the 16 resistors R3-1 to R3-16 are connected in series between the drain of the transistor TR4 and the ground. In addition, these resistors R3-1 to R3-16 have the same resistance and the same properties such as a temperature characteristic.

Furthermore, the connection point between the source of the transistor TR4 and the resistor R3-1 is connected to one end of the switch SW11. One end of the switch SW12 is connected to the connection point between the resistor R3-8 and the resistor R3-9. One end of the switch SW13 is connected to the connection point between the resistor R3-12 and the resistor R3-13. One end of the switch SW14 is connected to the connection point between the resistor R3-14 and the resistor R3-15. One end of the switch SW15 is connected to the connection point between the resistor R3-15 and the resistor R3-16. In addition, the other ends of the switches SW11, SW12, SW13, SW14, and SW15 are commonly connected to the terminal tm2 of the switch SW1.

Here, the output of the amplifier 271 is applied to the gate of the transistor TR4 together with the transistors TR1 and TR2. For this reason, the circuit portion including resistors R3-1 to R3-16 connected in series can be regarded as being connected in parallel to the BGR circuit including the resistors R1 and R2 and transistors Q1 and Q2 indicated by the temperature detection unit 273 in FIG. 5. In FIG. 5, based on the face that the voltage VPTAT at the collectors of the transistors Q1 and Q2 is obtained based on the former one (equation (3)), the voltage obtained from the connection point between the resistor R2 and the transistor TR1 also varies depending on the temperature. Therefore, the voltage between both ends of the series connection circuit of the resistors R3-1 to R3-16 regarded as being in parallel with the BGR circuit also varies depending on the temperature. Therefore, as shown in FIG. 5, it can be treated as the voltage VPTAT.

Furthermore, the switches SW11 to SW15 switches between on/off states depending on the gain to be set by the gain setting unit 109. When the gain to be set is 0 dB, the gain setting unit 109 turns on only the switch SW11 and turns off all of the remaining switches SW12 to SW15. In addition, when the gain is 6 dB, the switches SW11 and SW12 are turned on, and the switches SW13 to SW16 are turned off. When the gain is 12 dB, the switch SW11, SW12, and SW13 are turned on, and the switches SW14 and SW15 are turned off. When the gain is 24 dB, only the switch SW15 is turned on, and the switches SW11 to SW15 are turned on. In other words, the resistors R3-1 to R3-16 and the switches SW11 to SW14 constitute a variable voltage dividing circuit by which the voltage dividing ratio of the voltage VPTAT is variably set and output. Out of the switches SW11 to SW15 that carry out switching in this manner, the switch having an ON state corresponds to the voltage dividing point described in the claims of present application.

In this case, the voltages obtained from the other side (the terminal tm2 of the switch SW1) of the switches SW11 to SW15 depending on the switching of the switches SW11 to SW15 described above serves as the voltage VPTAT for each set gain. In other words, according to the second embodiment of the invention, the voltage VPTAT is controlled to change depending on the set gain.

As described above, the resistors R3-1 to R3-16 have the same resistance value. Therefore, the voltage VPTAT in this case has a voltage value obtained by dividing the voltage between both ends of the resistors R3-1 to R3-16 based on the voltage dividing ratio depending on the value of the gain scale factor which is variable. Specifically, if the voltage VPTAT is set to 1 for a gain of 0 dB (gain scale factor: 1), the voltage VPTAT is divided into ½ for a gain of 6 dB (gain scale factor: 2). Similarly, the voltage VPTAT is divided into ¼ for a gain of 12 dB (gain scale factor: 4), the voltage VPTAT is divided into ⅛ for a gain of 18 dB (gain scale factor: 8), and the voltage VPTAT is divided into 1/16 for a gain of 24 dB (gain scale factor: 16).

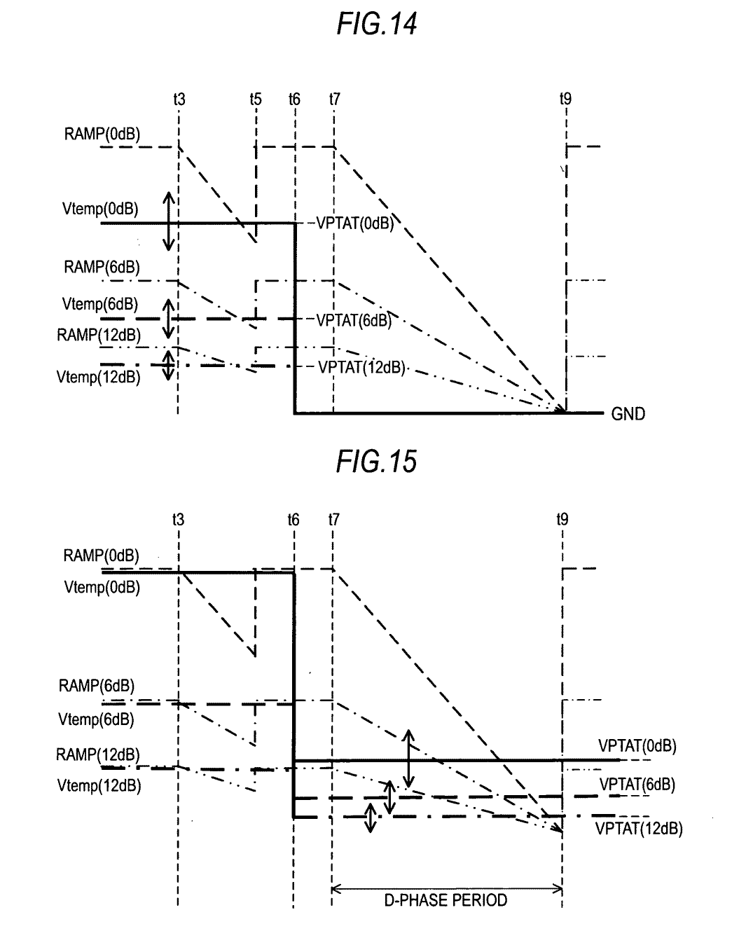

The waveform diagram of FIG. 14 illustrates the change of the waveform obtained in an actual operation for the reference signal RAMP and the temperature signal Vtemp according to the second embodiment of the invention. In addition, according to the second embodiment of the invention, the switch SW1 switches at the same timing as that of the first embodiment of the invention. Therefore, the temperature signal Vtemp is set to a voltage VPTAT before the time t6 and changed to the ground electric potential after the time t6. In addition, in FIG. 14, for the purpose of illustration, only the cases where the gain is set to 0 dB, 6 dB, and 12 dB are illustrated, and the cases where the gain is set to 18 dB and 24 dB are omitted.

As described above, the reference signal RAMP changes such that the inclination of the ramp waveform is reduced as the variably set gain increases. However, in practice, as the specified gain increases step by step, the initial voltage value thereof switches to decrease according to the gain scale factor. For example, for a predetermined time represented as a D-phase period t7 to t9, the ramp waveform is generated such that the electric current value is reduced from the initial voltage value to the ground electric potential. As a result, from the viewpoint of the inclination of the ramp waveform, the switching is made such that the inclination decreases as the gain increases.

In this case, for example, the inclination for a gain of 6 dB is set to ½ that for a gain of 0 dB. Furthermore, the inclination for a gain of 12 dB is set to ¼ that for a gain of 0 dB. Although not shown in the drawings, the inclination for a gain of 18 dB is set to ⅛ that for a gain of 0 dB, and the inclination for a gain of 24 dB is set to 1/16 that of a gain of 0 dB.

Meanwhile, the temperature signal Vtemp is changed from the voltage VPTAT output before the time t6 depending on the set gain by virtue of the configuration shown in FIG. 13. Specifically, with respect to a gain of 0 dB (a voltage level of 1), the voltage level of the temperature signal Vtemp is set to about ½ for a gain of 6 dB and about ¼ for a gain of 12 dB so that the electric potential difference between the voltage VPTAT and the ground voltage is gradually reduced as the gain increases. The temperature signal Vtemp shown in FIG. 14 can be regarded as a signal of which the electric potential can change depending on the temperature such that it is fixed to the ground electric potential after the time t6, and it is maintained at a voltage VPTAT before the time t6.

Here, as described above, input terminal electric potential reset is carried out for the comparator 241 at the timing before the P-phase period. This reset operation is carried out not only for the image comparators 241-1 to 241-(m−1) but also for temperature comparator 241m. FIG. 14 shows actual voltage values of the reference signal RAMP and the temperature signal Vtemp operated with respect to the ground electric potential. However, considering the input terminal electric potential reset described above, the electric potential relationship between the reference signal RAMP and the temperature signal Vtemp can be recognized as shown in FIG. 15. Specifically, it is recognized that the reference signal RAMP and the temperature signal Vtemp are input by shifting the levels to match with each other. As a result, the temperature comparator 241-m can set the levels of the initial voltage of the reference signal RAMP and the temperature signal Vtemp for the P-phase period to nearly the same electric potential.

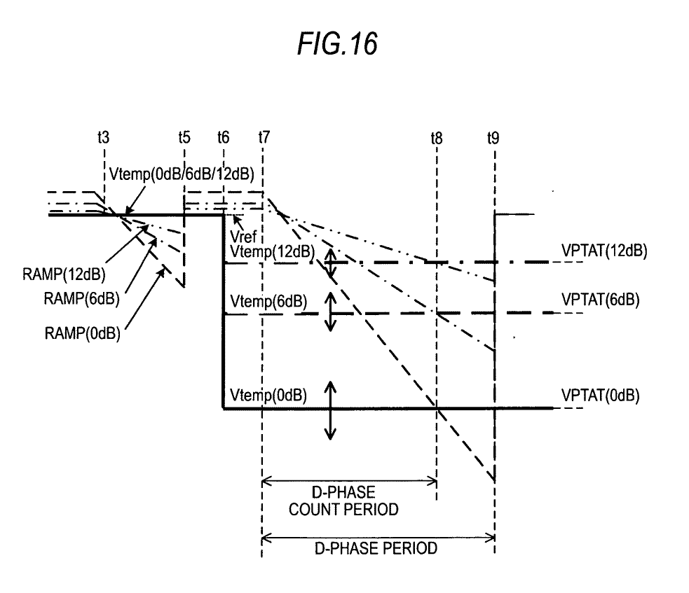

In addition, from the viewpoint of the electric potential difference between both input terminals of the temperature comparator 241-m, the reference signal RAMP and the temperature signal Vtemp of FIG. 15 can be illustrated as the timing chart of FIG. 16. In other words, FIG. 16 illustrates the operation of the temperature comparator 241-m in each case where the gain n is set to 0 dB, 6 dB, and 12 dB.

In FIG. 16, first, the temperature signal Vtemp has a virtual reference value Vref before the time t6. For this reason, the levels for gains of 0 dB, 6 dB, and 12 dB before the time t6 are equalized to be the same. As a result, while the temperature signal Vtemp is not related to the gain before the time t6, it changes at a ratio corresponding to the gain scale factor and the gains of 0 dB, 6 dB, and 12 dB after the time t6. In other words, when the gain is set to 6 dB (gain scale factor: 2), the level becomes twice the virtual voltage VPTAT for a gain of 0 dB. Furthermore, when the gain is set to 12 dB (gain scale factor: 4), the level becomes four times the virtual voltage VPTAT for a gain of 0 dB. Furthermore, the level of the temperature signal Vtemp obtained after the time t6 can be relatively treated as the virtual voltage VPTAT. In other words, the level of the temperature signal Vtemp is treated to vary depending on the temperature.

Focusing on the D-phase period (t7 to t9) of FIG. 16, for example, even when the gain is set to 6 dB or 12 dB which is higher than 0 dB, the level of the reference signal RAMP is changed to be lower than that of the temperature signal Vtemp at the time t8. In other words, even when the gain is higher than 0 dB, the D-phase count period is normally terminated within the D-phase period.

In addition, the termination timing of the D-phase count period as the time t8 is nearly the same for gains of 0 dB, 6 dB, and 12 dB. Therefore, the time length of the D-phase count period becomes also nearly the same, and the counter 242 obtains nearly the same count value when the down-count is terminated for gains of 0 dB, 6 dB, and 12 dB. In other words, it is possible to obtain the same count value regardless of gain change. This means that the temperature data Dt representing the temperature at that time are constantly and accurately obtained regardless of whether the gain changes.

In addition, although each waveform diagram of FIGS. 14 to 16 does not illustrate operational waveforms, for example, for gains of 18 dB and 24 dB, as understood from the description hereinbefore, the same operation as that described hereinbefore is obtained for each gain of 18 dB or 24 dB.

In this manner, according to the second embodiment of the invention, in the case where the imaging apparatus 100 has a configuration in which the gain changes, it is possible to normally create and output the temperature data Dt even when the gain changes to increase. Furthermore, it is possible to stably output the temperature data Dt representing the same temperature regardless of whether or not the gain changes.

In order to obtain the aforementioned effects, as shown in FIG. 13, a series connection circuit including a single MOS transistor TR4 and a necessary number of resistors R3-1 to R3-16 is added to the temperature detection unit 273A. In addition, a necessary number of switches SW11 to SW15 for changing the voltage dividing ratio may be added and connected to the power voltage VDD. In the case where such a number of components are added, for example, it is not necessary to enlarge the chip board size, and this does not hinder miniaturization.

Since the embodiments of the invention are just provided to exemplarily implement the present invention, as noted in the embodiments of the invention, a matching relationship is established between elements in the embodiments of the invention and particular elements of the invention described in the claims. Similarly, a matching relationship is established between particular elements described in the claims and elements in the embodiments of the invention having the same names. However, the invention is not limited to the embodiment, but various modifications may be made for the embodiments without departing from the scope of the invention.

For example, for purpose of simple and easy description, it has been assumed that the temperature ADC has been described as a single set corresponding to a single row of pixels. However, within the scope of the present invention, two or more sets of the temperature ADCs corresponding to two or more rows of pixels may be provided. In this case, for example, it is possible to obtain a plurality of pieces of frame period-related temperature data for each of a plurality of sets of temperature ADCs. In this regard, for example, it is anticipated that temperature information with higher precision can be obtained by further integrating or averaging a plurality of pieces of frame period-related temperature data.

While the embodiments of the invention have been described by exemplifying the temperature output device mounted in the CMOS image sensor, for example, the image sensor is not limited to the CMOS type according to the embodiment of the present invention. In addition, the configuration of the temperature output device according to the embodiment of the present invention may be applied to devices other than the image sensor. That is, the temperature output device may be mounted in the apparatuses other than the imaging apparatus.

The processing sequence described in the embodiments of the invention may be treated as a method including a set of such sequences or may be treated as a program for executing such a set of sequences in a computer or a recording medium that stores such a program. The recording medium may include, for example, a Compact Disc (CD), a MiniDisc (MD), a Digital Versatile Disk (DVD), a memory card, Blu-ray Disc (trade mark), or the like.

The present application contains subject matter related to that disclosed in Japanese Priority Patent Application JP 2010-051223 filed in the Japan Patent Office on Mar. 9, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A temperature information output apparatus comprising:
a first comparison unit that is provided to match with a single specific row of pixels in a pixel array unit in which pixels are arranged in a matrix shape and receives and compares as one input signal an analog pixel signal output from a pixel selected by row scanning in the matching row of pixels and as the other input signal a reference signal having a ramp waveform having a predetermined inclination depending on a reset period in which a reset level is obtained from the pixel signal and a signal period in which a signal level corresponding to a received light amount is obtained, the inclination of the reference signal varying depending on a gain specified for pixel data;
a first count unit that carries out a count operation during a count period within a reset period after the reset period is initiated until an output of the first comparison unit is inverted and a count period within a signal period after the signal period is initiated until an output of the first comparison unit is inverted;
a first data output unit that outputs the pixel data in a digital format based on a count value obtained through a count operation carried out by the first count unit during the count period within the signal period and the count period within the reset period;
a local voltage/temperature signal generating unit that generates a local voltage which has a predetermined voltage value different from a power voltage and is supplied to a predetermined circuit and generates a temperature signal obtained by changing a temperature-related voltage value which varies depending on temperature change based on a ratio corresponding to a specified gain;
a second comparison unit that receives and compares as one input signal the temperature signal and as the other input signal the reference signal having the ramp waveform;
a second count unit that carries out a count operation during a count period within a reset period after the reset period is initiated until the output of the second comparison unit is inverted and a count period within a signal period after the signal period is initiated until the output of the first comparison unit is inverted; and
a second data output unit that outputs temperature data in a digital format based on a count value obtained through the count operation carried out by the second count unit during the count period within the reset period and the count period within the signal period.

2. The temperature information output apparatus according to claim 1, wherein the local voltage generating unit generates a temperature-related voltage value as a voltage between both ends of a predetermined number of resistors connected in series, changes a voltage dividing point set in a series of the resistors based on a specified gain, and outputs the temperature signal from the voltage dividing point.

3. The temperature information output apparatus according to claim 1, wherein the second comparison unit is provided to match with a single specific row of pixels different from a row of pixels matching with the first comparison unit and receives the temperature signal instead of the pixel signal output from the specified matching row of pixels.

4. The temperature information output apparatus according to claim 3, wherein the specified row of pixels matching with the second comparison unit is a row of pixels within an image processing ineffective area including an ineffective pixel whose pixel signal is not used in image processing out of areas set in the pixel array unit.

5. The temperature information output apparatus according to claim 4, wherein period-related temperature data representing temperatures for each predetermined unitary period are created based on a plurality of pieces of temperature data output from the second data output unit in each predetermined unitary period.

6. The temperature information output apparatus according to claim 5, wherein the predetermined unitary period is a period based on a frame period.

7. An imaging apparatus comprising:
an optical system where light is incident;
a pixel array unit in which pixels receiving light incident to the optical system are arranged in a matrix shape;
a gain specifying unit that specifies a gain applied to pixel data created based on a signal obtained from pixels of the pixel array unit;
a reference signal generating unit that generates a reference signal having a ramp waveform having a predetermined inclination according to a signal period and a reset period of the pixel signal, the inclination changing depending on the gain specified by the gain specifying unit;
a first count unit that carries out a count operation during a count period within a reset period after the reset period is initiated until an output of the first comparison unit is inverted and a count period within a signal period after the signal period is initiated until an output of the first comparison unit is inverted;
a first data output unit that outputs the pixel data in a digital format based on a count value obtained through a count operation carried out by the first count unit during the count period within the signal period and the count period within the reset period;
a local voltage/temperature signal generating unit that generates a local voltage which has a predetermined voltage value different from a power voltage and is supplied to a predetermined circuit and generates a temperature signal obtained by changing a temperature-related voltage value which varies depending on temperature change based on a ratio corresponding to a specified gain;
a second comparison unit that receives and compares as one input signal the temperature signal and as the other input signal the reference signal having the ramp waveform;
a second count unit that carries out a count operation during a count period within a reset period after the reset period is initiated until the output of the second comparison unit is inverted and a count period within a signal period after the signal period is initiated until the output of the first comparison unit is inverted; and
a second data output unit that outputs temperature data in a digital format based on a count value obtained through the count operation carried out by the second count unit during the count period within the reset period and the count period within the signal period.

8. The imaging apparatus according to claim 7, further comprising a correction processing unit that executes correction for a predetermined correction target based on the temperature data.

9. The imaging apparatus according to claim 7, wherein the gain specifying unit determines the gain to be specified depending on exposure determined by an automatic exposure control.

10. A temperature information output apparatus comprising:
a first comparison unit that is provided to match with a single specific row of pixels in a pixel array unit in which pixels are arranged in a matrix shape and receives and compares as one input signal an analog pixel signal output from a pixel selected by row scanning in the matching row of pixels and as the other input signal a reference signal having a ramp waveform having a predetermined inclination depending on a reset period of the pixel signal and a signal period;
a first count unit that carries out a count operation during a count period within a reset period after the reset period is initiated until an output of the first comparison unit is inverted and a count period within a signal period after the signal period is initiated until an output of the first comparison unit is inverted;
a first data output unit that outputs the pixel data in a digital format based on a count value obtained through a count operation carried out by the first count unit during the count period within the signal period and the count period within the reset period;
a local voltage/temperature signal generating unit that generates a local voltage which has a predetermined voltage value different from a power voltage and is supplied to a predetermined circuit and generates a temperature signal obtained by changing a temperature-related voltage value which varies depending on temperature change based on a ratio corresponding to a specified gain;
a second comparison unit that receives and compares as one input signal the temperature signal and as the other input signal the reference signal having the ramp waveform;
a second count unit that carries out a count operation during a count period within a reset period after the reset period is initiated until the output of the second comparison unit is inverted and a count period within a signal period after the signal period is initiated until the output of the first comparison unit is inverted; and
a second data output unit that outputs temperature data in a digital format based on a count value obtained through the count operation carried out by the second count unit during the count period within the reset period and the count period within the signal period.

11. A method of outputting temperature information, the method comprising:
a first comparison process that, using a comparison unit provided to match with a single specific row of pixels in a pixel array unit in which pixels are arranged in a matrix shape, receives and compares as one input signal an analog pixel signal output from a pixel selected by row scanning in the matching row of pixels and as the other input signal a reference signal having a ramp waveform having a predetermined inclination depending on a reset period of the pixel signal and a signal period, the inclination of the reference signal varying depending on a gain specified for pixel data;
a first count process that carries out a count operation during a count period within a reset period after the reset period is initiated until an output of the first comparison process is inverted and a count period within a signal period after the signal period is initiated until an output of the first comparison process is inverted;
a first data output process that outputs the pixel data in a digital format based on a count value obtained through a count operation carried out by the first count process during the count period within the signal period and the count period within the reset period;
a local voltage/temperature signal generating process that generates a local voltage which has a predetermined voltage value different from a power voltage and is supplied to a predetermined circuit and generates a temperature signal obtained by changing a temperature-related voltage value which varies depending on temperature change based on a ratio corresponding to a specified gain;
a second comparison process that receives and compares as one input signal the temperature signal and as the other input signal the reference signal having the ramp waveform;
a second count process that carries out a count operation during a count period within a reset period after the reset period is initiated until the output obtained by the second comparison process is inverted and a count period within a signal period after the signal period is initiated until the output of the first comparison process is inverted; and
a second data output process that outputs temperature data in a digital format based on a count value obtained through the count operation carried out by the second count process during the count period within the reset period and the count period within the signal period.
